(19) United States
(12) Patent Application Publication
(10) Pub. No.: US 2017/0186272 A1
(43) Pub. Date: Jun. 29, 2017

(54) ONLINE GAMING USING MICRODENOMINATIONS

(71) Applicant: Rush Street Interactive, LLC, Chicago, IL (US)

(72) Inventors: Richard Schwartz, Chicago, IL (US); Greg Carlin, Lincoln Park, IL (US)

(73) Assignee: Rush Street Interactive, LLC, Chicago, IL (US)

(21) Appl. No.: 15/300,180

(22) PCT Filed: Mar. 30, 2015
(86) PCT No.: PCT/US2015/023422

§ 371 Date: Sep. 28, 2016

Related U.S. Application Data
(60) Provisional application No. 61/971,790, filed on Mar. 28, 2014.

(51) Int. Cl. G07F 17/32

(52) U.S. Cl. CPC G07F 17/3244; G07F 17/3227

(57) ABSTRACT

Disclosed herein are representative embodiments of methods, apparatus, and systems for facilitating online gaming (e.g., internet gaming) for games of chance involving real-money wagers. Particular embodiments concern low-stakes, microstake gaming and gaming platforms and/or game servers for supporting such games. Certain embodiments facilitate such microstake gaming even when the underlying game does not support such low-stake wagers.

### CROSS-REFERENCE TO RELATED APPLICATIONS

This application claims the benefit of U.S. Provisional Application No. 61/971,790, filed on Mar. 28, 2014, and entitled “ONLINE GAMING USING MICRODENOMINATIONS”, which is hereby incorporated herein by reference.

### FIELD

This application relates to online wagering games and platforms for facilitating such games.

### SUMMARY

Disclosed herein are representative embodiments of methods, apparatus, and systems for facilitating online gaming (e.g., internet gaming) for games of chance involving real-money wagers. The disclosed methods, apparatus, and systems should not be construed as limiting in any way. Instead, the present disclosure is directed toward all novel and/or nonobvious features and aspects of the various disclosed embodiments, alone or in various combinations and subcombinations with one another.

Particular embodiments concern low-stakes, “microstake” (or “microdenominational”) gaming and gaming platform servers and/or game servers for supporting such games. In general, microstakes gaming involves wagers that are less than the lowest available denomination for a real-world currency. In other words, the wager is less than the smallest monetary unit of a currency available and in circulation in the real-world. In the United States, for example, the wager is less than 1 cent (or penny); in the European Community, the wager is less than 1 euro cent; in the United Kingdom, the wager is less than 1 pence (or penny); in Australia, the wager is less than 1 cent; in South Africa, the wager is less than 1 cent; and so on for other countries.

The embodiments disclosed herein include embodiments that can be implemented by a game developer as well as embodiments that can be implemented at a system-wide level (e.g., for a gaming platform server or game server) and do not require further changes to the underlying game code in order to support microstakes wagering.

In certain example embodiments for facilitating microstakes wagering without modifying the underlying game code (implemented at least in part by, for instance, a gaming platform server or by a component of a game server separate from the underlying game code): a selection of a credit conversion rate is input from a user, the credit conversion rate describing how to convert a real-money account balance for the user into a number of credits available to the user for game play, the real-money account balance being for a real-world currency; a selection of a wager-based game for play by the user is input from the user; and the real-money account balance for the user is converted into the number of credits available to the user for game play of the selected wager-based game. In these example embodiments, the credit conversion rate results in a single one of the credits having a value in terms of the real-world currency that is less than a lowest real-world-available denomination of the real-world currency. The number of credits available to the user for game play for use with the selected wager-based game is transmitted (e.g., via an interface for the selected wager-based game and as part of launching the wager-based game). This data can be transmitted (via one or more suitable APIs) to, for example, a game server (such as a remote game server), which can then provide the data to the game module for the selected game (potentially via a separate API or game control mechanism). Or, in cases where a component of a game server separate from the underlying game code provides the microstakes support, this data can be passed (transmitted) directly to the game. In certain embodiments, upon completion of (or during) a game play session comprising a plurality of game plays of the selected wager-based game, an updated number of credits available to the user for game play is input; and the updated number of credits is converted into an updated real-money account balance using the selected credit conversion rate that was used to determine the number of credits available to the user transmitted as part of the launching of the wager-based game. In some embodiments, upon the user selecting to withdraw the updated real-money account balance, the real-money account balance is rounded to a real-world-available denomination of the real-world currency and transferred to the user. In embodiments in which updated game play information is provided as games within a game session are played, the updated game play information can be converted into a real-money game play information and presented to the user (e.g., by overlaying (or substituting) the updated real-money game play information onto an otherwise-original display of the game play or by providing the updated real-money game play information in a display portion adjacent to a display portion showing the game play).

In other example embodiments for facilitating microstakes wagering without modifying the underlying game code (implemented at least in part by, for instance, a gaming platform server or by a component of a game server separate from the underlying game code): a selection of a game offered by the online gaming platform is input from the user; a selection of a microstakes denomination for use with the selected game is input from the user, the microstakes denomination being represented in terms of a real-world currency but of a value that is less than a lowest real-world-available denomination of the real-world currency; a real-money account balance for the user is converted into a virtual account balance using the selected microstakes denomination, the real-money account balance being in terms of the real-world currency; and the virtual account balance for use during game play of the selected wager-based game is transmitted (via an interface and as part of launching the game). This data can be transmitted (via one or more suitable APIs) to, for example, a game server (such as a remote game server), which can then provide the data to the game module for the selected game (potentially via a separate API or game control mechanism). Or, in cases where a component of a game server separate from the underlying game code provides the microstakes support, this data can be passed (transmitted) directly to the game. In some embodiments, during a game play session for the selected wager-based game, updated game play statistics are received. The updated game play statistics can be converted into real-money game play statistics using the selected microstakes denomination, the real-money game play statistics including an updated real-money account balance. In certain embodiments, upon the user selecting to withdraw the updated real-money account balance, the real-money account balance is rounded to a real-world-available denomination of the real-world currency and transferred to the user (e.g., to another account associated with the user). In some embodiments, updated game play statistics are converted into real-money game play statistics using the selected microstakes denomination, and a display (also referred to as an image, user interface, or screen) is caused to be displayed to the user via a display device of the user's remote device, the display displaying the real-money game play statistics together with the selected wager-based game. For example, the display presented to the user can comprise one or more display portions that are overlayed onto (or replace portions of) a game play screen for the selected wager-based game and that display the updated game play statistics. As another example, the display presented to the user can comprise a real-money game play statistics display portion that displays the updated real-money game play statistics adjacent to a game play display portion that displays the game play.

Other example embodiments disclosed herein involve a computing device operated by a user and configured to provide online, internet-based, gaming with microstakes support via, for example, communication with a remote gaming platform server and/or remote game server (e.g., through a web browser or dedicated app executed at the computing device). In one example implementation, through one or more game lobby screens displayed to the user, a user is allowed to (a) select a wager-based game for play by the user, and (b) select a credit conversion rate to convert a real-money account balance for the user into a number of credits available to the user for game play, the real-money account balance being for a real-world currency, the credit conversion rate resulting in a single one of the credits having a value in terms of the real-world currency that is less than a lowest monetary unit of the real-world currency available in the real world. Through one or more game play screens displayed to the user, a user is allowed to play one or more games of the selected wager-based game using a number of credits converted from the real-money account balance using the selected credit conversion rate. In another example implementation, through one or more game lobby screens displayed to the user, a user is allowed to (a) select a wager-based game for play by the user, and (b) select a microstakes denomination for use in converting a real-money account balance for the user into a virtual account balance for use with the selected wager-based game, the microstakes denomination being represented in terms of a real-world currency but of a value that is less than a lowest monetary unit of the real-world currency available in the real world, the real-money account balance being in terms of the real-world currency. Through one or more game play screens displayed to the user, the user is allowed to play one or more games of the selected wager-based game using the virtual account balance for the user converted from the real-money account balance using the selected microstakes denomination.

Also disclosed herein are examples of games that have been originally designed or been modified to support microstakes wagering. Such games can be stored, for instance, on a game server and made available for play by a user. For instance, in one example embodiment, a game server comprising one or more processing units and one or more tangible non-transitory computer-readable media, the one or more tangible non-transitory computer-readable storing computer-executable instructions which when executed by one or more of the processing units cause the game server to facilitate game play of one or more wager-based games at a remote device operated by a user (e.g., a mobile device communicating with the game server via the internet). In such embodiments, at least one of the one or more wager-based games is a microstakes-supporting wager-based game that allows the user to make a wager in terms of a real-world currency but in an amount that is less than a smallest real-world monetary unit of the real-world currency. In certain embodiments, the microstakes-supporting wager-based game displays one or more of wager amounts, wins, or available balance via respective display portions showing values to three or more decimal places (e.g., four decimal places, five decimal places, six decimal places, and so on). In some embodiments, the microstakes-supporting wager-based game is a modified version of a wager-based game that did not natively support microstakes wagers.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram illustrating a computing environment in which aspects of the disclosed technology can be performed.

FIG. 2 is a block diagram showing a first exemplary network environment in which aspects of the disclosed technology can be performed.

FIG. 3 is a block diagram showing a second exemplary network environment in which aspects of the disclosed technology can be performed.

FIG. 4 is a schematic block diagram that illustrates an exemplary framework for implementing embodiments of the disclosed technology.

FIG. 5 is an example screen shot of a slot game in which account balances are tracked as a microdenominational (or fractional) currency value.

FIG. 6 is an example screen shot of a slot game facilitating microstake wagering in which account balances are tracked as a credit value.

FIG. 7 is an example screen shot that schematically shows a low-stakes game lobby that includes one or more credit conversion buttons that are selectable by a user based on the user's desired conversion rate.

FIG. 8 is another example screen shot of a low-stakes game lobby where conversion buttons allow the user to select a desired microstakes denomination for a game.

FIG. 9 is a flowchart illustrating an example for implementing a microstakes wager via a gaming platform according to one exemplary embodiment of the disclosed technology.

FIG. 10 is an example screen shot of a slot game in which account balances are tracked as a credit value.

FIG. 11 shows a screenshot of an original game display in which wagers and account information are tracked and displayed in terms of real-money currency values. FIG. 11 also shows a screenshot of a modified game display in which one or more display portions are modified to display support for microstakes wagering.

FIG. 12 shows another screenshot of an original game display as in FIG. 11 and a modified screenshot where the game display is reduced in size and supplemental real-money game statistics with microstakes support are provided in a display portion made available through the reduction in size of the original display.

FIG. 13 is a flowchart illustrating another example for implementing a microstakes game via a gaming platform according to an exemplary embodiment of the disclosed technology.

FIG. 14 is a block diagram illustrating with more specificity components of an example internet gaming platform and remote game server as in FIG. 3.

FIG. 15 is a schematic block diagram of an exemplary mobile device environment in which embodiments of the disclosed technology can be implemented.

FIGS. 16A and 16B illustrate a generalized example of a mobile device suitable for implementing embodiments of the disclosed technology.

FIGS. 17-20 are flowcharts illustrating example embodiments of the disclosed technology.

### DETAILED DESCRIPTION

### I. General Considerations

Disclosed herein are representative embodiments of methods, apparatus, and systems for facilitating online gaming (e.g., internet gaming) for games of chance involving real-money wagers. The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed embodiments can be used in various combinations and subcombinations with one another. For example, one or more method acts from one embodiment can be used with one or more method acts from another embodiment and vice versa. The disclosed methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” and “receive” to describe the disclosed methods. These terms may be high-level abstractions of the actual operations that are performed. The actual operations that correspond to these terms may vary depending on the particular implementation and are readily discernible by one of ordinary skill in the art. Additionally, as used herein, the term “and/or” means any one item or combination of items in the phrase.

### II. Introduction to the Disclosed Microstakes Technology

With online casino gaming gaining greater acceptance, legalization, and popularity, the number of online players is expected to increase dramatically. Many players, however, are not comfortable with wagering significant amounts of real money, and would instead prefer a lower stakes opportunity that provides a minimal financial risk but allows for prolonged gaming sessions. The online environment is well suited for such low-stake wagering. For instance, the online environment does not require actual casino real estate, amenities, physical building maintenance, or gaming machine maintenance to be performed. Generally speaking, the rationale for facilitating low-stake gaming according to embodiments of the disclosed technology is to create low-stakes betting opportunities that are less than the lowest available denomination (monetary unit) of a real-world currency (referred to herein as a “microstake” or “microdenomination”) so that online players can extend the frequency and duration of their online play. Further, when online gaming platforms are offered by land-based casinos, the online gaming platform offers the land-based casino the opportunity to attract an online casino player demographic that may otherwise not be able to afford to play the same slot machines at the price points typically offered in land-based casinos.

One significant challenge with providing online low-stakes casino games is that game developers do not offer low-stake games natively. Instead, game developers typically design their gaming titles as land-based games with certain real-world-currency minimal stakes in place (typically, at least 1¢ bet per line). Consequently, when these game developers convert their slot-machine titles into online slot-machine titles, they use the same minimal stake requirements as the original themes and do not modify the price point to accommodate a different distribution channel.

Disclosed herein are embodiments for low-stakes online slot games and gaming platforms for support such games. Particular embodiments facilitate microstakes gaming.

Embodiments of the disclosed technology involve wager-based games in which real-money wagers are bet on games of chance that provide real-money winnings. For instance, the wager-based games involve consideration, chance, and the possibility of an award or prize. The wager-based games and gaming environments discussed herein are distinguishable from online games (such as play-for-fun, social, or free games) that provide no real-money stakes or real-money redeemable (or withdrawable) winnings or awards. As discussed herein, the wager-based games can be adapted or implemented in a manner that provides microstakes support.

Embodiments of the disclosed technology involve gaming platform servers and game servers having specialized game management and/or game components programmed or configured to facilitate online gaming with microstakes wagering support. Several of the particular disclosed system interactions, user interactions, data transactions and transformations, and/or components did not exist prior to the invention of the disclosed technology or in any pre-internet or non-online context whatsoever. Still further, certain aspects of the disclosed technology solve problems that are unique to online systems and that are rooted in the computer and/or network technology in which they appear. For example, embodiments of the disclosed technology can exhibit any one or more of the following advantages over conventional approaches and systems: (a) overcoming the inherent lack of microstakes support in online wager-based games (and, in some cases, the need to modify game code to provide microstakes support) by providing unique methods and mechanisms that can be implemented at the gaming platform level to facilitate microstakes gaming, even when the native code for a game does not support microstake wagering; (b) overcoming the lack of microstakes support in online wager-based games offered by a third-party vendor at a remote game server by providing unique methods and mechanisms for interfacing with the game server (e.g., by a gaming platform server) to facilitate microstakes gaming; (c) overcoming the constrained set of wagers available to a player in online wager-based games that are ported from land-based games by either offering modified versions of the games or by providing methods and mechanisms at the gaming platform level that facilitate microstakes gaming without the need to modify games; (d) overcoming the inability of a player to view his or her actual account balance or to view actual game play information when playing a non-microstakes-supporting game using microstakes wagers by providing unique displays and user interfaces that allow for the display of actual real-money values with microstakes support during microstakes gaming; (e) overcoming the reluctance of players to play wager-based games because of the financial risk by providing players with lower-stakes wagering opportunities not confined by real-world-currency denominational requirements; and/or (f) overcoming the conventional wisdom that a wager-based game must have a required return to the operator in order to pay for real estate, amenities, building maintenance, or game maintenance by offering microstakes wagering opportunities that produce less return but attract new players and/or prolong gaming sessions.

A variety of computational and hardware resource benefits can also be realized using embodiments of the disclosed technology. For instance, in certain embodiments disclosed herein, the native game code for a game remains unchanged and the microstakes support is provided by an interface layer that performs microstakes selection, conversion, and/or display functionalities without disturbing the underlying game play and code. Such embodiments allow for reduced computational effort and resource usage for those hardware components dedicated to implementing the underlying wager-based game. Moreover, such embodiments obviate the time-consuming need for game reprogramming and extra storage and memory requirements associated with games that are specifically adapted to support microstakes wagering along with non-microstakes wagering. For instance, the gaming platform server (or components of the game server separate from the game code) can be configured to provide the microstakes support across multiple wager-based games using a common interface mechanism. By having the microstakes support being provided at the game platform level (or by components of the game server separate from the game code) and having the same interface mechanism available for multiple wager-based games that do not natively support microstakes (as opposed to strictly requiring the games themselves to provide microstakes support), the memory and other computational resources used to store and execute the wager-based games (and otherwise implement the game server functions) can be reduced and/or more efficiently used. On the other hand, wager-based games that have game code adapted to provide microstakes support can help reduce the computational burden and hardware resource burden experienced by the game platform server (e.g., by eliminating the need for a separate interface mechanism for providing microstakes support). Thus, the computational and hardware resource benefits that can be realized from embodiments of the disclosed technology are embodiment specific and can depend on the resources available and/or where the benefit is desired to be achieved.

Still further, embodiments of the disclosed technology are uniquely adapted to maintain player interest in a game for longer periods of time. For instance, the microstakes wagering opportunities enabled by embodiments disclosed herein allow for prolonged game play and also present the user with unique game play experiences that generate further player interest. For instance, in situations where a player's current balance of credits or microdenomination lies in between the lowest available denomination in the real-world currency, the player can be incentivized to continue game play until the balance resolves to a monetary unit available in the real world because, for example, earlier withdrawal may have the consequence of the balance being rounded downwardly.

### III. Example Computing Environments for Implementing Embodiments of the Disclosed Microstakes Technology

Any of the disclosed methods can be implemented as computer-executable instructions stored on one or more computer-readable media (e.g., non-transitory computer-readable media, such as one or more optical media discs, volatile memory components (such as DRAM or SRAM), or nonvolatile memory components (such as hard drives, solid state drives, or Flash memory)) and executed on a computer (e.g., any commercially available computer, including desktop computers, servers, mobile phones, smart phones, tablet computers, netbooks, wearable computers (such as smart watches), or other devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application or gaming app). Such software can be executed, for example, on a single local computer or in a network environment (e.g., via the internet, a wide-area network, a local-area network, a client-server network (such as a cloud computing network), or other such network) using one or more network computers. For example, a gaming app can be downloaded to a mobile device (such as a mobile phone, smart phone, tablet computer, or wearable computer) from an “app store” and installed locally on the computing device. The gaming app can be configured to interact with a gaming platform server and/or a remote game server in order to exchange game play and/or account information and can be configured to implement the gaming platform and/or games locally or by interfacing with the gaming platform and/or remote game server during game play in order to provide the gaming platform and game play experience. The gaming embodiments disclosed herein can also be provided through an app hosted by a social media provider. Further, the embodiments of the disclosed technology can also be implemented through software that provides a browser-based gaming experience (e.g., through a dedicated website or through a website hosted by a social media provider).

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Java EE, Adobe Flash, Adobe AIR, HTML5, or any other suitable programming language, including combinations thereof. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the internet, the World Wide Web, an intranet, cable (including fiber optic cable), magnetic communications, electromagnetic communications (including RF, microwave, and infrared communications), electronic communications, or other such communication means.

The disclosed methods can also be implemented by specialized computing hardware that is configured to perform any of the disclosed methods. For example, the disclosed methods can be implemented (entirely or at least in part) by an integrated circuit (e.g., an application specific integrated circuit (“ASIC”) or programmable logic device (“PLD”), such as a field programmable gate array (“FPGA”)). The integrated circuit can be embedded in or directly coupled to an electrical device having a suitable display device.

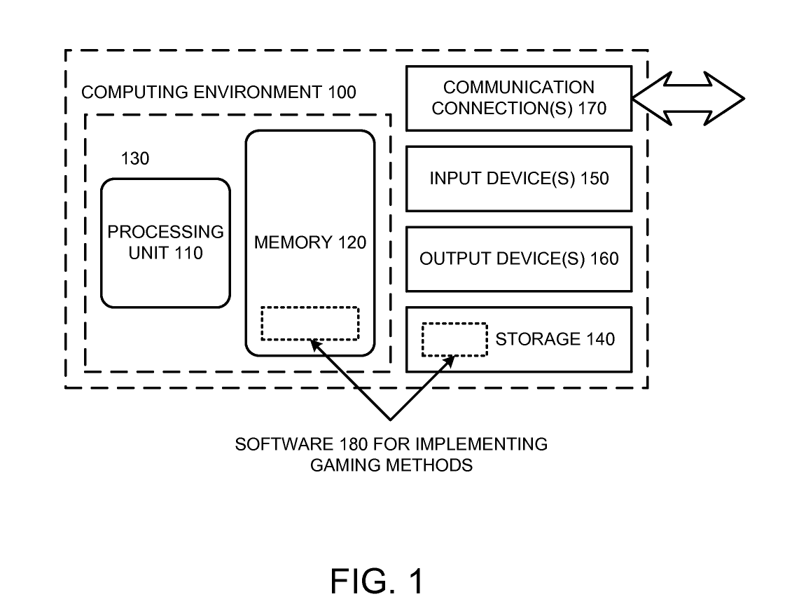

FIG. 1 illustrates a generalized example of suitable computing hardware 100 with which embodiments of the disclosed technology can be implemented. The computing hardware 100 is not intended to suggest any limitation as to the scope of use or functionality of the disclosed technology, as the techniques and tools described herein can be implemented in diverse general-purpose or special-purpose environments that have computing hardware.

With reference to FIG. 1, the computing hardware 100 includes at least one processing unit 110 and memory 120. In FIG. 1, this most basic configuration 130 is included within a dashed line. The processing unit 110 executes computer-executable instructions. In a multi-processing system, multiple processing units execute computer-executable instructions to increase processing power. The memory 120 may be volatile memory (e.g., registers, cache, RAM), non-volatile memory (e.g., ROM, EEPROM, flash memory), or some combination of the two. The memory 120 stores software 180 for implementing one or more of the described embodiments. For example, the memory 120 can store software 180 for implementing any of the disclosed techniques described herein and their accompanying user interfaces.

The computing environment can have additional features. For example, the computing hardware 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 140 can be removable or non-removable, and includes magnetic disks, magnetic tapes or cassettes, CD-ROMs, DVDs, or any other such tangible non-transitory nonvolatile memory or storage medium which can be used to store information and which can be accessed within the computing environment 100. The storage 140 can also store instructions for the software 180 implementing any of the described techniques, systems, or environments.

The input device(s) 150 can be a touch input device such as a keyboard, touchscreen, mouse, pen, trackball, a voice input device, a scanning device, or another device that provides input to the computing environment 100. The output device(s) 160 can be a display device (e.g., a computer monitor, smartphone display, tablet display, netbook display, or touchscreen), printer, speaker, CD-writer, or another device that provides output from the computing environment 100.

The communication connection(s) 170 enable communication over a communication medium to another computing entity. The communication medium conveys information such as computer-executable instructions or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier. The communication connection(s) 170 can include hardware for implementation such communications (e.g., a suitable network card, wireless transceiver, and the like).

As noted, the various methods can be described in the general context of computer-readable instructions stored on one or more computer-readable media. Computer-readable media are any available media that can be accessed within or by a computing environment. By way of example, and not limitation, with the computing environment 100, computer-readable media include tangible non-transitory computer-readable media such as memory 120 and storage 140 but do not include transitory signals or carrier waves per se.

The various methods disclosed herein can also be described in the general context of computer-executable instructions, such as those included in program modules, being executed in a computing environment by a processor. Generally, program modules include routines, programs, libraries, objects, classes, components, data structures, and so on that perform particular tasks or implement particular abstract data types. The functionality of the program modules may be combined or split between program modules as desired in various embodiments. Computer-executable instructions for program modules may be executed within a local or distributed computing environment.

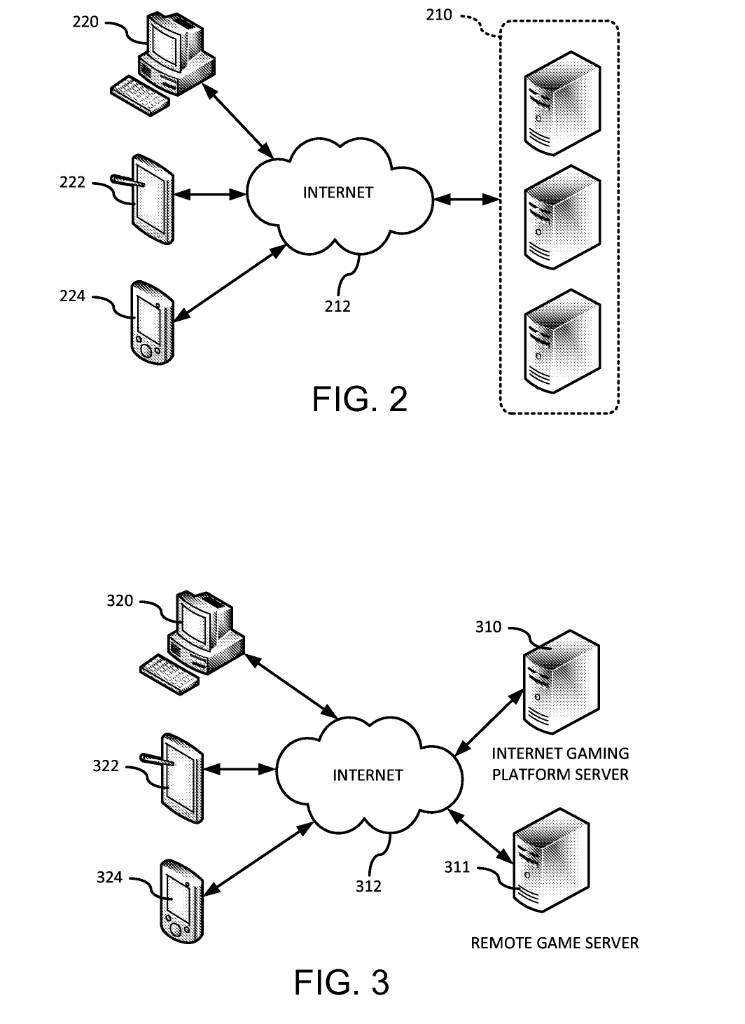

An example of a possible network topology (e.g., a client-server network, an internet-connected network, or cloud-based network) for implementing a system according to the disclosed technology is depicted in FIG. 2. Networked computing devices 220, 222, 224 can be, for example, computers running a browser, plug-in, or other software that communicates with one or more internet gaming platform computers 210 (e.g., one or more servers in a cloud computing environment or one or more dedicated servers) via network 212 (e.g., a network that at least partially includes the internet, as illustrated, or other network, such as a LAN). The one or more internet gaming platform computers 210 can include a server configured to provide the gaming platform, a separate server configured to host and facilitate game play of one or more games, and/or a separate server configured to handle user payment and credit card information and to comply with any applicable payment card security standards (e.g., PCI security standards). Any of these services can alternatively be provided by a single server. Further, the servers can be virtual servers configured to easily migrate, install, and co-exist on the underlying server hardware.

The computing devices 220, 222, 224 and the internet gaming platform computers 210 can have computer architectures as shown in FIG. 1 and discussed above. The computing devices 220, 222, 224 are not limited to traditional personal computers but can comprise other computing hardware configured to connect to and communicate with the network 212 (e.g., smart phones (such as smart phone 224), tablets (such as tablet 222), or other mobile computing devices, servers, network devices, dedicated devices, and the like).

In the illustrated embodiment, the computing devices 220, 222, 224 are configured to communicate with the one or more internet gaming platform computers 210 via a network 212 (e.g., a network that at least partially includes the internet). In certain implementations, the internet gaming platform computers 210 execute software for performing any of the disclosed low-denomination gaming methods (e.g., any of the gaming selection or lobby functions or game play functions or features). In some embodiments, the interface provided to the user through which the user can select a game and/or denomination is referred to as a gaming “lobby” or gaming “room”. The internet gaming platform computers 210 can transmit data to and receive data from any of the computing devices 220, 222, 224 in order to implement the disclosed game lobby functionalities and games (e.g., to transmit game play data or game play data converted to show real-money game information with microstakes support to the computing devices as well to receive user selections made by the user of the computing devices (such as a selected wager amount, selected paylines, selected bets per payline, selections made during a game feature, and other such user-inputted information commonly used in wager-based games)). In some example embodiments, executable code can be downloaded from the computers 210 to implement the gaming lobby and games locally on the devices 220, 222, 224; or, alternatively, data for rendering (or pre-rendered data for) user interfaces or other displays can be sent from the one or more computers 210 to the devices 220, 222, 224 (in other words, the game lobby and games are executed by computers 210, but image content data for displaying the game and lobby to the player (e.g., in real-time or substantially real-time) is sent to the devices 220, 222, 224).

In FIG. 2, the one or more internet gaming platform computers 210 are controlled by an internet gaming platform operator and include the game servers that facilitate game play with a player. Another example of a possible network topology for implementing a system according to the disclosed technology is depicted in FIG. 3. In FIG. 3, the game servers that facilitate game play with a player are separate from the internet gaming platform servers and can be operated by different entities. For instance, the game servers can be remote game servers that are controlled and operated by a third-party game vendor.

In FIG. 3, networked computing devices 320, 322, 324 can be, for example, computers running a browser or other software connected to a network 312 (e.g., a network that at least partially includes the internet, as illustrated, or other network, such as a LAN). As above, the computing devices 320, 322, 324 as well as the internet gaming platform server 310 and the remote game server 311 can have computer architectures as shown in FIG. 1 and discussed above. The computing devices 320, 322, 324 are not limited to traditional personal computers but can comprise other computing hardware configured to connect to and communicate with a network 312 (e.g., smart phones (such as smart phone 324), tablets (such as tablet 322), or other mobile computing devices, servers, network devices, dedicated devices, and the like).

In the illustrated embodiment, the computing devices 320, 322, 324 are configured to communicate with a computing device 310 via the network 312. In particular embodiments, the computing device 310 is an internet gaming platform server configured to implement a gaming platform that allows a respective user of the devices 320, 322, 324 to select a desired game to play and/or to select a desired denomination (or credit conversion rate) for wagers made in the game. As more fully explained below, the internet gaming platform can be used to facilitate the low-stakes gaming methods disclosed herein. In some embodiments, the interface provided to the user through which the user can select a game and/or denomination is referred to as a gaming “lobby” or gaming “room”.

In some embodiments, the computing device 310 is configured to communicate with a separate server (not shown) configured to handle user payment and credit card information and to comply with any applicable payment card security standards (e.g., PCI security standards). In other embodiments, however, the user payment and credit card information is maintained in the same server as the internet gaming platform.

Further, in certain embodiments of the illustrated architecture, the computing device 310 and the computing device 311 are configured to communicate with each other (e.g, via one or more application programming interfaces (“APIs”) that specify a communication protocol between the devices 310, 311) and facilitate game play for a user. In the illustrated embodiment, the computing device 310 can be an internet gaming platform server and the computing device 311 can be a game server configured to provide one or more games for play at the computing devices 320, 322, 324. The game server 311 can be a remote game server operated by a third-party game vendor. This inter-server communication between computing device 310 and computing device 311 can be through a public network (such as the internet, as illustrated) or through a dedicated network (e.g., a LAN).

In certain embodiments, once a game is selected, the computing devices 320, 322, 324 are configured to communicate with the separate computing device 311 configured to implement the desired game selected by the user. For instance, in some implementations, the computing devices 320, 322, 324 communicate only with the computing device (game server) 311 during game play (e.g., to receive game play data (or game play data converted to show real-money game information with microstakes support) from the game server 311 at the devices 320, 322, 324, as well to receive user selections from the user of any of the computing devices 320, 322, 324 (e.g., a selected wager amount, selected paylines, selected bets per payline, selections made during a game feature, and other such user-inputted information commonly used in wager-based games) at the game server 311). In other implementations, the computing devices 320, 322, 324 communicate with the computing device (game server) 311 as well as the computing device (internet gaming platform server) 310 during game play (e.g., to receive game play data from the game server 311 and converted game play data to show real-money game information with microstakes support from the internet gaming platform server 310 at the devices 320, 322, 34, as well to receive user selections made by the user of the computing devices 320, 322, 324 (e.g., a selected wager amount, selected paylines, selected bets per payline, selections made during a game feature, and other such user-inputted information commonly used in wager-based games) at the internet gaming platform server 310 and/or game server 311). In still other implementations, the computing devices 320, 322, 324 communicate only with the computing device (internet gaming platform server) 310 during game play (e.g., to receive game play data converted to show real-money game information with microstakes support from the internet gaming platform server 311 at the devices 320, 322, 324, as well to receive user selections from the user of any of the computing devices 320, 322, 324 (e.g., a selected wager amount, selected paylines, selected bets per payline, selections made during a game feature, and other such user-inputted information commonly used in wager-based games) at the internet gaming platform 310). This situation may arise, for example, for configurations in which the game server 311 passes game play information to the internet gaming platform server 310, which then supplements the game play information and transmits a modified version of the data to the computing devices 320, 322, 324, as discussed more fully below).

In general, one or more of the computing devices 310, 311 can transmit data to any of the computing devices 320, 322, 324 for implementing the disclosed gaming platform functionalities and/or game play functionalities. For instance, executable code can be downloaded from the computers 310, 311 to locally implement the gaming methods on the devices 320, 322, 324; or, alternatively, data for rendering (or pre-rendered data for) user interfaces (e.g., game play displays that allow for user input) or other displays can be sent from any of the computers 310, 311 to the devices 320, 322, 324 (for instance, in certain embodiments, the game lobby (or game room) functionalities are executed by internet gaming platform server 310 and the selected game is executed by the remote game server 311, and image content data for displaying the game lobby (or game room) functionalities as well as the game play functionalities are sent to the devices 320, 322, 324 from the computing devices 310, 311, respectively).

In the illustrated embodiments, the networks 212, 312 can be implemented at least in part using the internet or a similar public network and operate using an appropriate protocol (e.g., the HTTP protocol). The illustrated networks 212, 312 can also include a Local Area Network (“LAN”) using wired networking (e.g., the Ethernet IEEE standard 802.3 or other appropriate standard) or wireless networking (e.g. one of the IEEE standards 802.11a, 802.11b, 802.11g, or 802.11n, which are commonly used for WiFi networks, or other appropriate standard). Further, data transmitted through the networks 212, 312 to or from any of the devices or servers can be transmitted using a secure sockets layer (“SSL”) connection.

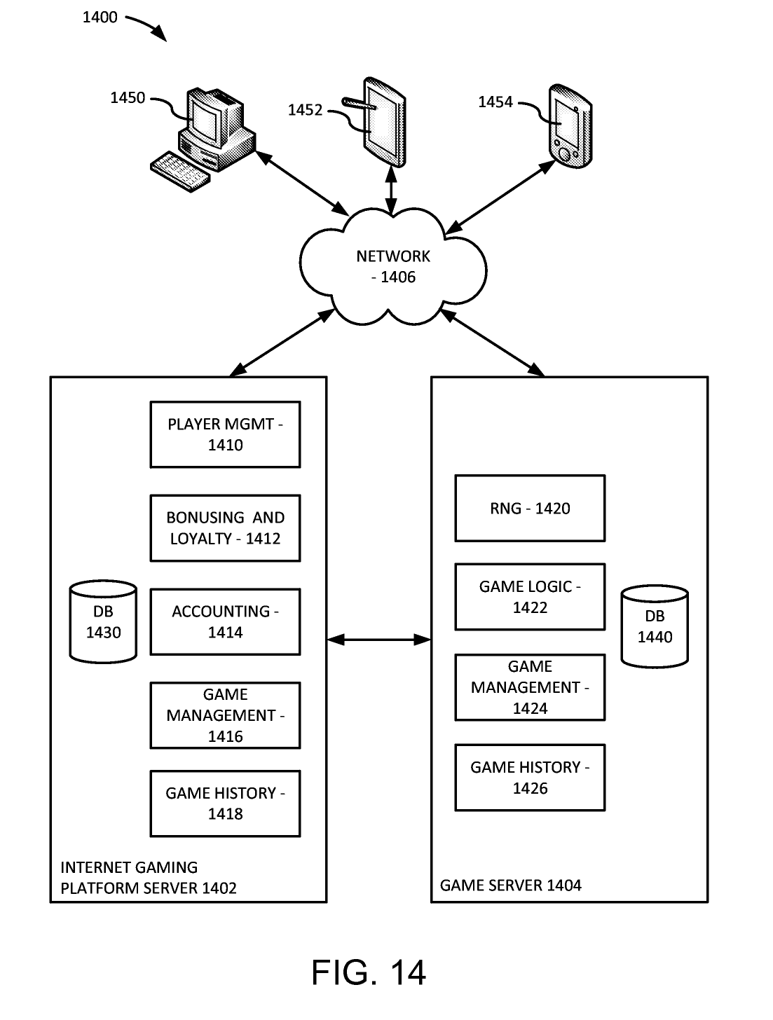

FIG. 14 is a schematic block diagram 1400 illustrating various components of an exemplary internet gaming platform server 1402 (such as an internet gaming platform server used in computers 210 or server 310) and a game server 1404 (such as a game server used in computers 210 or remote game server 311). The various components are by way of example only and not to be construed as limiting. Instead, any of the components can be used alone or in any combination or subcombination with one another, as well as with other components. Further, in other embodiments, one or more components from the internet gaming platform server 1402 can be implemented in the game server 1404 and vice versa. The internet gaming platform server 1402 and the game server 1404 can have computer architectures as shown in FIG. 1 and discussed above.

In the illustrated embodiment, the internet gaming platform server 1402 and the game server 1404 are configured to communicate with any of computing devices 1450, 1452, 1454 (e.g., using an SSL connection) or other computing devices via a network 1406, which may be at least partially implemented by a public network such as the internet. (References to the “internet gaming platform server” in this description have been used for convenience but should be construed as being equally applicable to a gaming platform server which uses a different type of network.) The computing devices can be, for example, any of a personal computer 1450, a tablet device 1452, or a smart phone 1454, operated by a user (player) but can also be any other computing device with access to the network. The internet gaming platform server 1402 and the game server 1404 are also configured to communicate with each other (e.g, via one or more application programming interfaces (“APIs”) for the platform server 1402 and the game server 1404, respectively). This inter-server communication can also be through a public network (such as the internet) or through a dedicated network (e.g., a LAN). In some embodiments, the game server 1404 can be a remote game server operated by a third-party vendor (entity) different from the operator of the internet gaming platform server 1402 and can communicate with the internet gaming platform server 1402 over the internet. Still further, in certain embodiments, any one or more of the components of the internet gaming platform server 1402 and the game server 1404 are implemented as part of a single server.

In the illustrated embodiment, the internet gaming platform server 1402 is configured to facilitate game play for a player (e.g., operating any of the computing devices 1450, 1452, 1454) by coordinating access to games on one or more game servers, such as game server 1404, controlling wagering options (e.g., according to any of the embodiments disclosed below), and managing player account activities. The internet gaming platform server 1402 can comprise a variety of components (e.g., implemented as one or more software modules) for providing the gaming platform functionalities. For instance, in the illustrated embodiments, the internet gaming platform server 1402 comprises a player management component 1410, a bonusing and loyalty component 1412, an accounting component 1414, a game management component 1416, and/or a game history component 1418, any one or more of which can be configured to store and/or retrieve data from a platform database 1430.

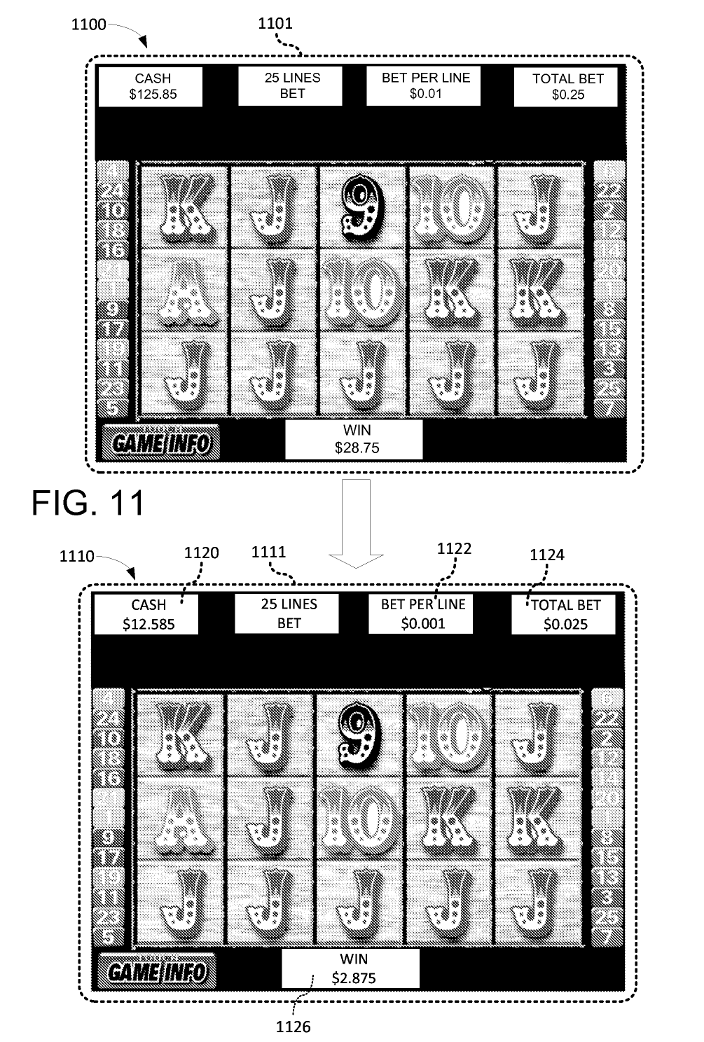

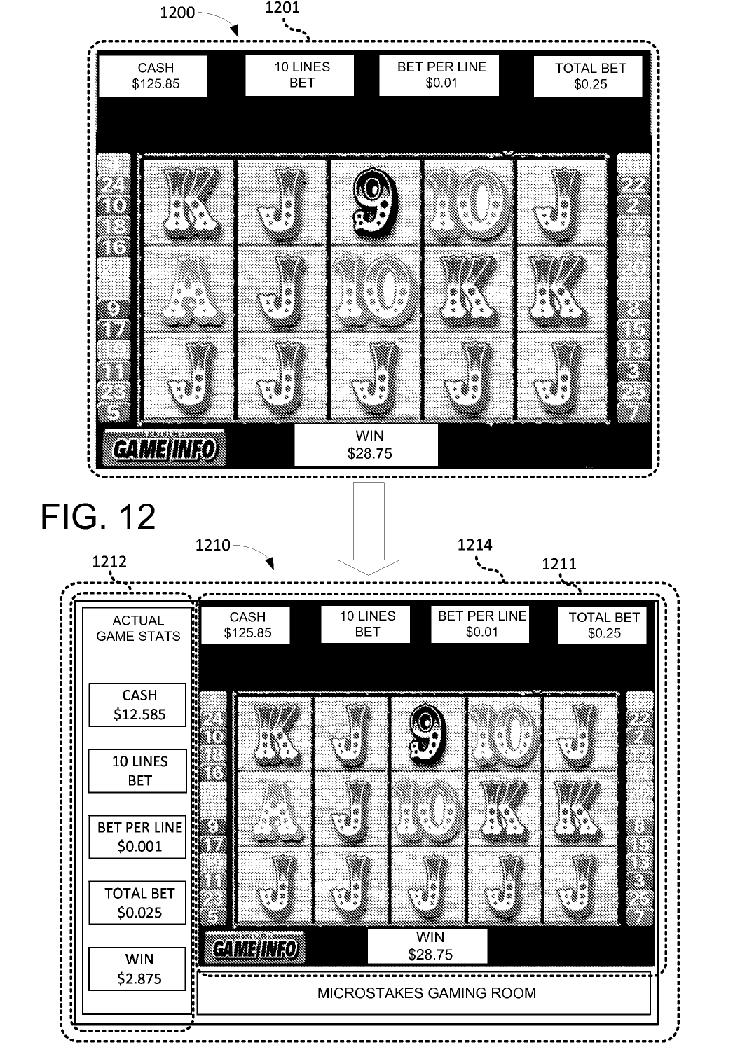

The player management component 1410 can be configured to perform player registration, player verification, and player profile maintenance operations. The bonusing and loyalty component 1412 can be configured to maintain a player's loyalty program data and provide awards and/or incentives to the player according to the rules of the loyalty program. The bonusing and loyalty component 1412 can also be configured to store and provide bonuses to players in accordance with any bonus offers provided through the system (e.g., bonus amounts added to a player's account upon registration, upon deposit of a certain amount of money, upon game play during certain “happy hour” times, etc.). The accounting component 1414 can maintain a player's account information and may, in some embodiments, interact with another server storing a player's personal payment card information. The accounting component 1414 can also include a module for handling withdrawals or deposits of funds (e.g., by interfacing with a player's bank account or credit card company). Additionally, the accounting component 1414 can perform rounding operations as described herein in order to account for a conversion from a microstakes-supported account balance to a real-world account balance (e.g., upon selection of a user to withdraw funds). Further, when a game is selected for play by a user, the accounting component 1414 can be configured to provide a total account balance for use during game play of the selected game (which is sometimes referred to as a seamless wallet approach), or provide a portion of the total balance (which can be selected by the user) which is provided as a separate account balance for use during game play of the selected game. The game management component 1416 can be configured to store a list of games supported by the platform and to launch and appropriately configure the games upon selection by a user. In some implementations, the game management component 1416 also provides web-hosting or other services that provide an interface to the player (e.g., a game lobby), or provides a downloadable application that provides the interface to the player. For instance, the game management component 1416 can provide a browser-based gaming experience (e.g., through a dedicated website or through a website hosted by a social media provider) or provide the game-play experience via a downloadable app with which the game management component interfaces during game lobby operations and/or game play. In other implementations, the website or app providing the game lobby to the user is separate from the internet gaming platform and the game management component (e.g., as part of a separate layer that interfaces with the platform). The game management component 1416 can also be configured to interact with and facilitate game play with the game server 1404. For example, the game management component 1416 can include a messaging module for interfacing with the game server 1404 via an API. For instance, in some cases, the game management component 1416 can receive from a remote user a selection of a game available on the game server 1404 and launch the game (e.g., by interfacing with the game server 1404 through an API to start the game and exchange the desired information (such as player identification and available balance (or credits) for game play). In some embodiments, the game server 1404 then interfaces directly with the remote user to provide the game play experience. In such embodiments, the game server 1404 may operate to provide game play information to the gaming platform server 1402 as game play progresses (e.g., on a game-by-basis, including wager selection and in-game (e.g., game feature) activity) or after a game play session of multiple games is complete (e.g., upon a user selecting to exit a game). In other embodiments, the game server 1404 transmits information to the gaming platform server 1402, which interfaces with the remote user to provide the game play experience. For instance, in one example implementation to provide microstakes support without modifying game code, the game management component 1416 can receive game play information (e.g., data indicating the outcome of a game as determined by random number generator component 1420 and game logic 1422) and/or game play image data from the remote game server 1404, perform any of the microstakes conversions disclosed herein, and cause the display of real-money statistics together with the game play for the wager-based game on a display device of a remote computing device operated by the remote user (e.g., as in FIGS. 11 and 12 discussed below). This can be performed, for example, by rendering the display screen at the gaming platform server 1402 (using, for instance, the game management component) and transmitting image content data for the rendered image to the remote device. Or, data regarding the real-money statistics, game play, and/or game play images (e.g., data indicating the outcome of a game and/or other associated image content data) can be transmitted to the remote device for local rendering at the remote user's device. In some implementations, the gaming platform server 1402 is configured to receive game play and/or other game play image content data from the game server 1404, process such data (e.g., to provide the simultaneous display of the real-money statistics with the game play (such as shown in FIGS. 11 and 12)), and transmit data (e.g., image content data) for causing the desired display on the remote device. In still other embodiments, both the game server 1404 and the gaming platform server 1402 interface with the remote user during game play to provide the game play experience. For instance, data can be sent from both the gaming platform server 1402 and the game server 1404 to the remote user's device to produce the desired display (e.g., the display of real-money statistics together with the game play for the wager-based game as in FIGS. 11 and 12). To provide microstakes support, the game management component 1416 can be configured or programmed to perform or facilitate any of the microstakes selection and conversion techniques disclosed herein so that microstakes wagering is supported for a game, even when the game does not natively support such microstakes wagering. Further, the game management component 1416 can communicate with the accounting component 1414 to obtain player account information during game launch and/or to update the player account information during game play or upon completion of a game play session (after performing any conversion to account for microstakes wagering and wins) so that the accounting component 1414 maintains accurate account information for a player. The game history component 1418 can be configured to maintain and store a player's game play history for accounting and/or compliance purposes. It is to be understood that the components and functionalities described above are by way of example and not limitation. Any of the functionalities can be performed by other components in the server 1402 or even by other components that interface with the server. For example, any of the microstakes conversion techniques that are described herein and that provide support for microstakes wagering may be performed by the accounting module 1414 instead of the game management module 1416.

The remote game server 1404 in FIG. 14 can comprise a random number generator (“RNG”) component 1420, game logic component 1422, game management component 1424, and/or a game history component 1426, any one or more of which can be configured to store and/or retrieve data from a remote game server database 1440.

The random number generator component 1420 can comprise one or more random number generator modules that provide random numbers to game logic for purposes of facilitating game play. The random number generator component 1420 can comprise, for example, a module that has been approved by a gaming authority in one or more jurisdictions. The game logic component 1422 can be configured to provide the actual game play for a game selected for play by a player and include the game assets (e.g., game graphic and animation data, game audio data, reel strip data, game feature data, paytable data, and other such game play data). The game management component 1424 can be configured to interact with and facilitate game play with the internet gaming platform server 1402 (e.g., by receiving a game request for a player along with game configuration information, and facilitating the local launch and delivery of the game to the player from the game server). For instance, the game management component 1424 can include a messaging module for interfacing with the internet gaming platform server 1402 via the platform's and/or the game server's API. In some cases, each game module in the game server 1404 may have its own (potentially unique) game-specific API or control mechanism, in which case the game management component 1424 also interfaces with the game-specific API or game control mechanism (e.g., after performing any necessary translation or data formatting) to facilitate the communication between the internet gaming platform server 1402 and the game module. Further, for embodiments in which the game server 1404 at least partially interfaces directly with the remote user's device, the game management component 1424 can include a module for facilitating such communication. Further, the game management component 1424 can include a module for performing player authentication operations and/or in-game funds handlings. The game history component 1426 can be configured to maintain and store a player's game play history for accounting and/or compliance purposes. It is to be understood that the components and functionalities described above are by way of example and not limitation. Any of the functionalities can be performed by other components in the server 1404 or even by other components that interface with the server.

In the example description above, support for microstakes wagering is provided by the gaming platform (e.g., by the gaming platform server 1402). It is to be understood that support for microstakes wagering can also be provided by one or more components or modules within the game server 1404. For instance, the game server 1404 may have a component (e.g., the game management component 1424) that provides for microstakes support according to any of the disclosed microstake selection, conversion, and/or display techniques described herein. This component can still be separate from the game code that drives the selected game (e.g., as part of the game logic component 1422) such that the game code is not modified, thereby enabling microstakes gaming in situations whether the game code does not natively provide microstakes support. This game server component can perform any of the credit or balance conversions for microstakes wagering (as part of game launch, during game play, and/or upon a game session being completed, as discussed below) and interface with the game (e.g., via a game-specific API or other game-specific control mechanism) as described above with respect to game management component 1416. Further, this game server component can perform any of the described display techniques for providing the microstakes-supported displays, as in FIGS. 11 and 12. Still further, this game server component may provide a microstakes wager selection interface through which a player can select a desired microstakes wager amount as disclosed herein. In such embodiments, the gaming platform server 1402 can still interface with the game server 1404 (via the platform's and/or game server's API) and provide game selection and initial game configuration data to the game server 1404 (e.g., data indicating a selected game, player identification, available balance for use during game play, and other such initiation data), but the support for microstakes gaming using any of the disclosed techniques is provided through an interface layer of the game server.

For any of the internet gaming platform server and game server embodiments described above or elsewhere herein, it is to be understood that the precise character and content of the data transmitted between the platform server 1402 and the game server 1404 as well as to and from the remote computing devices 1450, 1452, 1454, will vary depending on the implementation. For example, in some embodiments, the remote computing devices 1450, 1452, 1454 operate as remote game clients and download some code and game assets for local execution and use during play of a particular game. The game code can include code for rendering the game display (including any of the modified displays disclosed herein) in response to receipt of certain information from the gaming platform server 1402 and/or the game server 1404 (e.g., game play information that includes game outcome data and converted gaming statistics data). The game code can also include code for determining and sending user requests to the gaming platform server 1402 and/or the game server 1404 (e.g., data concerning a player's desired wager, paylines, bets per payline, selections during a game feature, or any other user input used during game play). For instance, in some particular implementations, any of the remote computing devices 1450, 1452, 1454 may have at least some of the image asset and/or reel strip data for a game downloaded locally so that it can locally render an image of the game results using a relatively small set of image content data sent by the gaming platform 1402 and/or game server 1404. In these implementations, the RNG component, paytable data, and win determination logic are typically performed by the game server 1404 (e.g., for regulatory purposes). The image content data used for local rendering in such implementations can comprise game play information that includes game outcome data, such as the random numbers determined from the RNG component, the amount of a win determined from the paytable, and/or the account balance after a win. The image content data may also include information that originated from any of the computing devices 1450, 1452, 1454 (e.g., the number of paylines bet, the amount bet per payline, and/or the total amount bet) via user selection but which, in some examples, is processed, accepted, and passed back to the device 1450, 1452, 1454 by the gaming platform 1402 and/or game server 1404 (e.g., as part of game play information). Any of the image content data described can be modified or supplemented to support microstakes wagering according to embodiments disclosed herein.

In some embodiments, the exchange of data between the internet gaming platform server 1402, the game server 1404, and/or the remote computing devices 1450, 1452, 1454, is performed substantially continuously. Therefore, for embodiments in which microstakes support is provided for games that do not natively has such support, the user can view any modified or supplemental data showing microstakes game statistics in real-time or substantially real-time.

A variety of suitable gaming platforms can be used and/or adapted to implement the embodiments of the disclosed technology. Online gaming platforms and/or game servers provided by, for example, NYX Gaming Group, Playtech, or Amaya, among others, can be adapted for use with the disclosed technology.

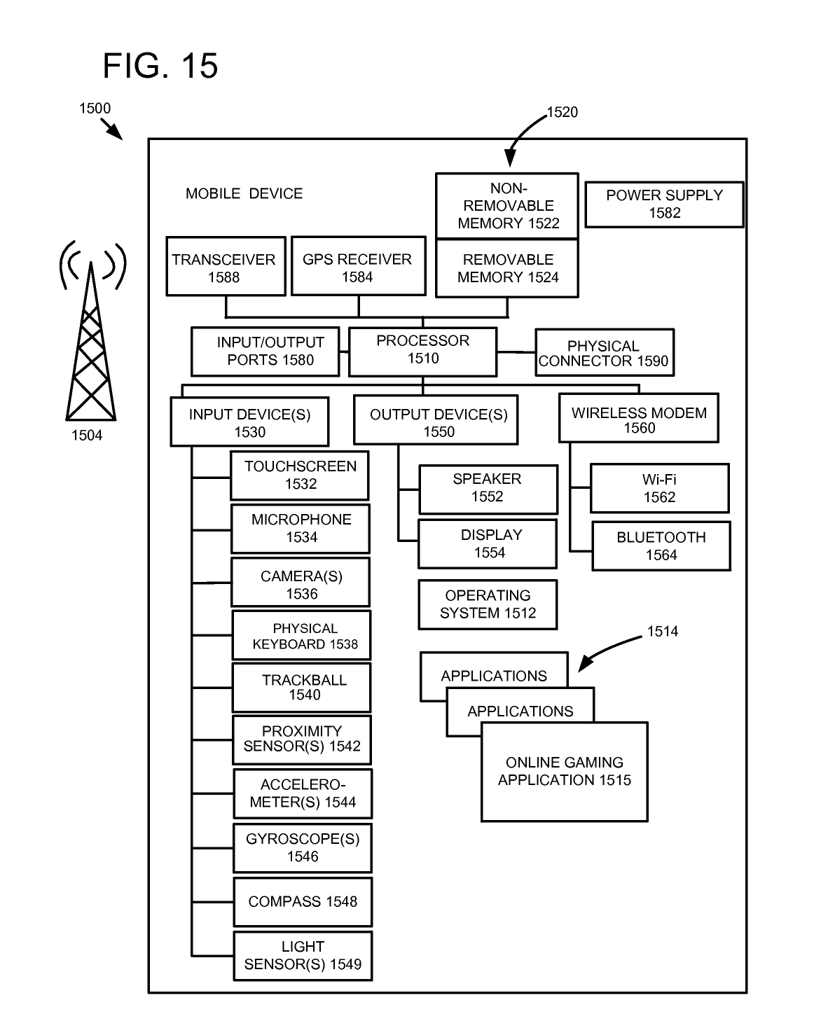

As noted, the internet gaming platform server 1402 and/or the game server 1404, can communicate and facilitate game play on a mobile device with which the internet gaming platform server 1402 and/or the game server 1404 communicate. FIG. 15 is a schematic block diagram depicting a detailed example of a mobile computing device 1500 capable of implementing embodiments of the disclosed technology (e.g., capable of displaying and providing interaction mechanisms for use with embodiments of the disclosed online gaming methods and systems (e.g., via communication with a gaming platform server/game server (via a website or application) as disclosed herein)). The mobile device 1500 includes a variety of optional hardware and software components. In general, a component in the mobile device can communicate with any other component of the device, although not all connections are shown, for ease of illustration. The mobile device can be any of a variety of computing devices (e.g., a cell phone, smartphone, handheld computer, laptop computer, notebook computer, tablet computer, media player, PDA, or other such mobile devices) and can allow wireless two-way communications with one or more mobile communications networks 1504, such as a Wi-Fi, cellular, or satellite network.

The illustrated mobile device 1500 includes a controller or processor 1510 (e.g., signal processor, microprocessor, ASIC, or other control and processing logic circuitry) for performing such tasks as signal coding, data processing, input/output processing, power control, and/or other functions. An operating system 1512 controls the allocation and usage of the components and support for one or more application programs 1514, such as an online gaming application 1515 that implements one or more of the innovative features described herein. The application programs can further include common mobile computing applications (e.g., telephony applications, email applications, calendars, contact managers, web browsers, social network applications, messaging applications), or any other computing application.

The illustrated mobile device 1500 includes memory 1520. Memory 1520 can include non-removable memory 1522 and/or removable memory 1524. The non-removable memory 1522 can include RAM, ROM, flash memory, a hard disk, or other well-known memory storage technologies (e.g., non-transitory computer-readable storage media). The removable memory 1524 can include Flash memory or a Subscriber Identity Module (“SIM”) card, which is well known in Global System for Mobile Communications (“GSM”) communication systems, or other well-known memory storage technologies, such as “smart cards.” The memory 1520 can be used for storing data and/or code for running the operating system 1512 and the applications 1514 (including the application 1515). Example data can include web pages, text, images, sound files, video data, or other data sets to be sent to and/or received from one or more network servers or other devices via one or more wired or wireless networks. The memory 1520 can be used to store a subscriber identifier, such as an International Mobile Subscriber Identity (“IMSI”), and an equipment identifier, such as an International Mobile Equipment Identifier (“IMEI”). Such identifiers can be transmitted to a network server to identify users and equipment.

The mobile device 1500 can support one or more input devices 1530, such as a touchscreen 1532 (e.g., capable of capturing finger tap inputs, finger gesture inputs, multi-touch finger tap inputs, multi-touch finger gesture inputs, or keystroke inputs for a virtual keyboard or keypad), microphone 1534 (e.g., capable of capturing voice input), one or more cameras 1536 (e.g., capable of capturing still pictures and/or video), physical keyboard 1538, trackball 1540, one or more proximity sensors 1542, one or more accelerometers 1544, one or more gyroscopes 1546, compass 1548, one or more light sensors 1549, and/or buttons. The mobile device 1500 can further support one or more output devices 1550, such as a speaker 1552 and a display 1554. Other possible output devices (not shown) can include piezoelectric or other haptic output devices. Some devices can serve more than one input/output function. For example, touchscreen 1532 and display 1554 can be combined in a single input/output touchscreen.

The mobile device 1500 can provide one or more natural user interfaces (“NUIs”). For example, the operating system 1512 or applications 1514 can comprise speech-recognition software as part of a voice user interface that allows a user to operate the device 1500 via voice commands.

A wireless modem 1560 can be coupled to one or more antennas (e.g., transceiver 1588) and can support two-way communications between the processor 1510 and external devices, as is well understood in the art. The modem 1560 is shown generically and can include, for example, a cellular modem for communicating at long range with the mobile communication network 1504, a Bluetooth-compatible modem 1564, or a Wi-Fi-compatible modem 1562 for communicating at short range with an external Bluetooth-equipped device or a local wireless data network or router. The wireless modem 1560 is typically configured for communication with one or more cellular networks, such as a GSM network for data and voice communications within a single cellular network, between cellular networks, or between the mobile device and a public switched telephone network (“PSTN”).

The mobile device can further include at least one input/output port 1580, a power supply 1582, a satellite navigation system receiver 1584, such as a Global Positioning System (“GPS”) receiver, a transceiver 1588 (for wirelessly transmitting analog or digital signals) and/or a physical connector 1590, which can be a USB port, IEEE 1394 (FireWire) port, and/or RS-232 port. The illustrated components are not required or all-inclusive, as any of the components shown can be deleted and other components can be added.

The mobile device 1500 can be part of an implementation environment in which various types of services are provided by a computing “cloud.” For example, the cloud can comprise a collection of computing devices, which may be located centrally or distributed, that provide cloud-based services to various types of users and devices connected via a network such as the internet. Some tasks (e.g., processing user input and presenting a user interface) can be performed on local computing devices (e.g., connected devices) while other tasks (e.g., performing game play and gaming platform services) can be performed in the cloud.

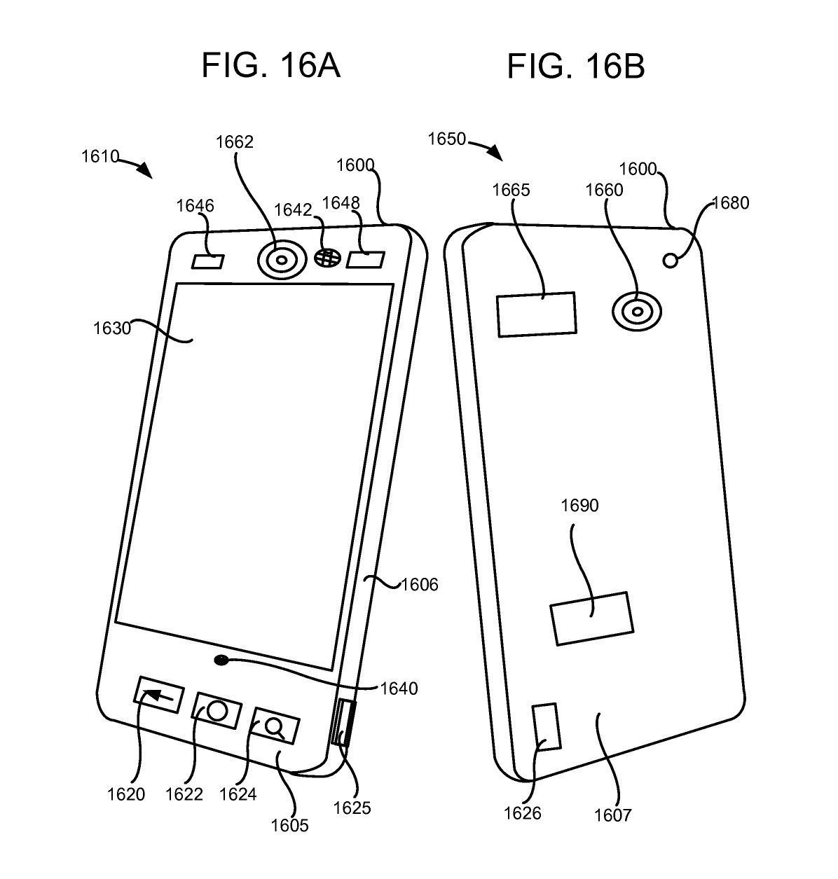

FIG. 16A depicts a front view 1610 of the body of an example mobile device 1600, while FIG. 16B depicts a rear view 1650 of the mobile device 1600. As shown, the mobile device 1600 includes several hardware buttons, including a “back” button 1620, a home button 1622, a search button 1624, and a camera shutter (image-capture) button 1625. Also depicted is a touchscreen display 1630.

The mobile device 1600 includes a microphone 1640 and speaker 1642, along with two proximity sensors 1646 and 1648, situated below the surface of the mobile device. In some examples, a single, or three or more, proximity sensors can be used. Any suitable proximity sensor(s) can be employed. The front face of the example mobile device 1600 further includes a front camera 1662. The camera 1662 can be used to capture images or video with an image sensor embedded in the device 1600 behind a lens. The image sensor can comprise, for example, a CMOS-based sensor, CCD (charge-coupled device) sensor, or other suitable technology.

Turning to the rear view 1650 shown in FIG. 16B, the example mobile device 1600 includes a rear camera lens 1660 and an electronic flash 1665. In some examples, there is no flash present in the mobile device 1600. The rear camera 1660 can be configured to capture an image or video with an image sensor embedded in the device behind a lens. The image sensor can be, for example, a CMOS-based sensor, CCD (charge-coupled device) sensor, or other suitable technology.

The individual components (e.g., the hardware buttons 1620, 1622, 1624, and 1625, microphone 1640, speaker 1642, touchscreen display 1630, camera lens 1660 and flash 1665) can be coupled to a mobile device chassis (not shown), which is connected to internal components of the mobile device 1600, for example: one or more processors, a piezoelectric actuator, a power supply, and a modem.

As shown, software 1690 for implementing embodiments of the described online gaming techniques can be stored on computer-readable storage media (e.g., non-transitory computer-readable storage media) in the mobile device 1600.

### IV. Example Embodiments for Facilitating Low-Stakes Online Gaming

This section describes example embodiments for facilitating low-stake online games, specifically microstake gaming in which the wager is less than the lowest available denomination for a real-world currency. In other words, the wager is less than the smallest monetary unit of a currency available and in circulation in the real-world. In the United States, for example, the wager is less than 1 cent (or penny); in the European Community, the wager is less than 1 euro cent; in the United Kingdom, the wager is less than 1 pence (or penny); in Australia, the wager is less than 1 cent; in South Africa, the wager is less than 1 cent; and so on for other countries. Further, the lowest available denomination for a real-world currency will typically be a denomination that is a subunit of a main (or base) unit (e.g., in the United States, the lowest available denomination refers to 1 cent, which is a subunit of the dollar main unit).

Generally speaking, the embodiments can be categorized as embodiments that can be implemented by a game developer and embodiments that can be implemented at a system-wide level for a gaming platform and do not require further changes to the underlying games supported by the gaming platform.

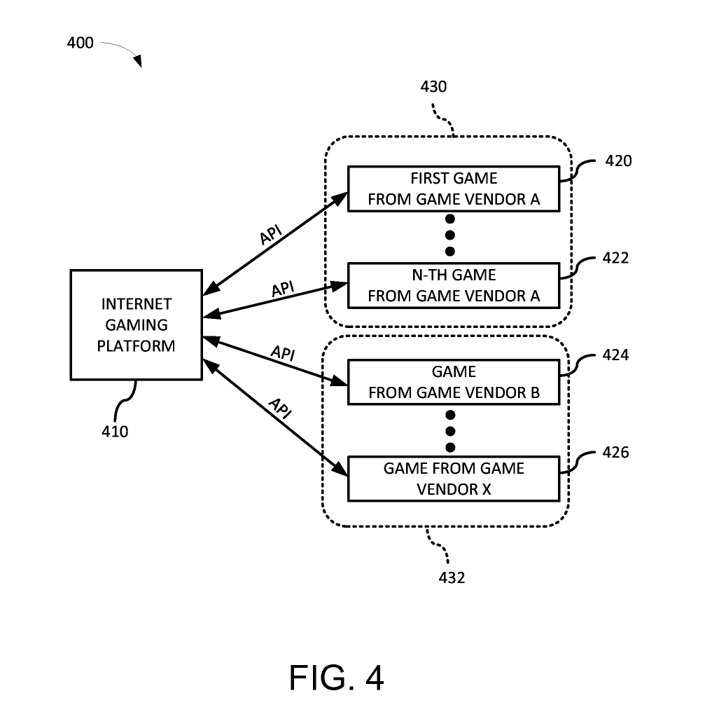

FIG. 4 is a schematic block diagram that illustrates an exemplary framework 400 for implementing embodiments of the disclosed technology. The example framework 400 includes an internet gaming platform 410 (e.g., implemented by an internet gaming platform server, such as server 210, 310, or 1402) that serves as the primary interface and coordination component for facilitating gaming and tracking of user account information. The internet gaming platform 410 may be implemented as a separate software tool (or suite of tools) that flexibly provides interaction and execution control of one or more game instances. For instance, in the illustrated embodiment, the internet gaming platform 410 is configured to allow a user to launch and interface with games hosted by a first remote game server 430 as well as games hosted by a second remote game server 432. The internet gaming platform 410 can operate and/or include any of the components described above with respect to internet gaming platform server 210, 310, and/or 1402, and the first and second remote game servers 430, 432 can operate and/or include any of the components as described above with respect to servers 210, 311, and/or 1404. In the illustrated embodiment, the first remote game server 430 hosts one or more games from a common vendor, illustrated as first game instance from game vendor A 420 and n-th game instance from game vendor A 422. The second remote game server 432 hosts a variety of games, including games from different vendors. For instance, in FIG. 4, games from different vendors are illustrated as a game 424 from game vendor B and a game 426 from game vendor X. For instance, the game server 432 can aggregate games from various vendors. The remote game servers 430, 432 can host any number of game instances.

The internet gaming platform 410 can be configured to operate or coordinate the play of any number of game instances. In the online environment, it is easier for games from different game developers to be made available to a player through a single gaming platform. For instance, in the illustrated embodiment, first and n-th games 420, 422 are provided by vendor A (via remote game server 430) whereas games 424, 426 are provided by different vendors (via remote game server 432).

In particular implementations, and as discussed above with respect to FIG. 14, the game instances are configured to operate with the gaming platform via at least one interface through which game information can be passed to the game module from the gaming platform and from the game module to the gaming platform. The interface can be, for example, one or more application programming interfaces (“API”) that operates according to a defined communication protocol (e.g., written and specified by the game developer and/or gaming platform). In operation, when a game is launched from the gaming platform, the interface may receive data indicating, among other things, a player's account balance so that the game can apply the account balance to its credit meter (or account meter) and accurately track the remaining balance as game play proceeds. Other information may also be passed through the interface (e.g., game-by-game information, such as an amount wagered, an amount won, number of paylines selected, amount bet per payline, player tracking information, etc.). The interface may be used on a game-by-game basis (allowing for information to be passed between the game server and the gaming platform server in substantially real-time with the game play) or at the beginning and end of a gaming session in which multiple plays of the game are made by the player. In some examples, the operator of the internet gaming platform may provide a game developer kit (or software developer kit) that specifies the requirements, APIs, protocols, and/or options available on a particular platform, thus allowing developers to more easily implement games for the platform.

A. Example Game Math Modifications

This section describes various embodiments for modifying a game to support microstakes wagering. Typically, the modifications would be made by a game developer at the source code level. Also described are gaming platform modifications that could be made to support the games having native microstakes wagering capability.

One exemplary approach to facilitate microstakes gaming is to add a third (or further) decimal place to the minimum stake button (per spin), account balance meter, or other meters or display portions of the game. Support for the third (or further) decimal place can be provided for each game (e.g., by the game developers for games 420, 422, 424, 426) as well as by the gaming platform itself (e.g., gaming platform 410).

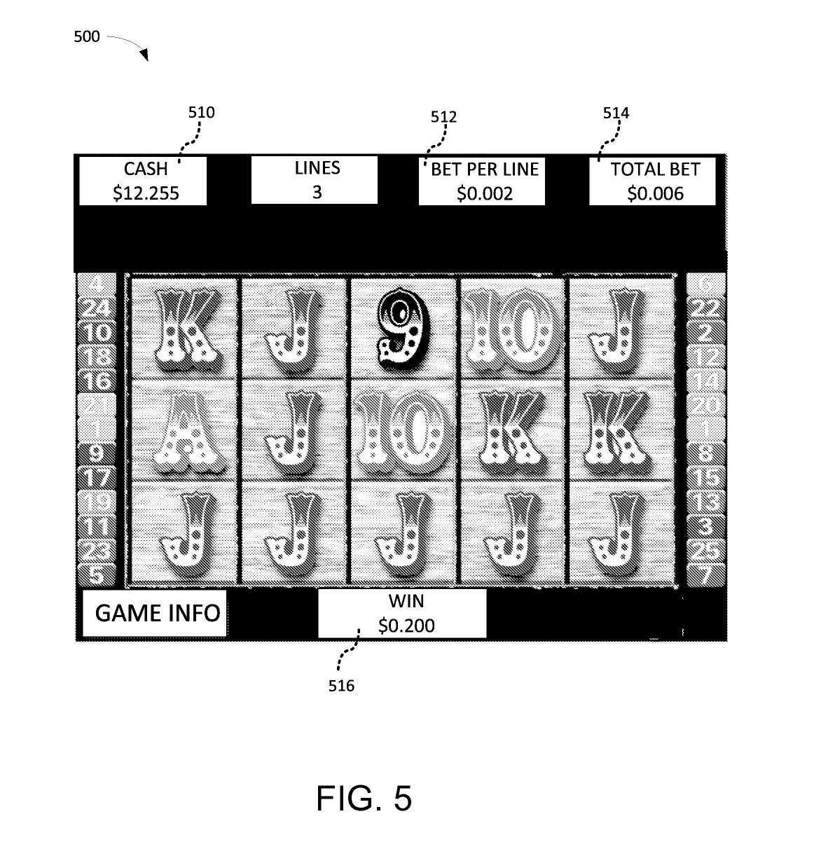

An example screen shot of a game developed with support for a third decimal place is illustrated in FIG. 5. In particular, FIG. 5 is an example screen shot 500 of a slot game in which account balances are tracked as a real-world currency value (here, dollars). As can be seen, the display portions that display the account balance, the current amount wagered per line, the value of the current wager, and/or the amount won in the current game are adapted to support a third decimal place. Specifically, in the illustrated implementation, account balance display portion 510 (e.g., the account balance available on the internet gaming platform), bet-per-line display portion 512, total bet display portion 514, and total-win display portion 516 include a third decimal place for tracking the respective game information to a further decimal place. In this example, support for the third decimal place is provided in the native code for the game.

In other embodiments, additional decimal place support is added to provide even lower fractional wagers. For instance, a fourth, fifth, or any other additional decimal place can be added.

In embodiments when a third or greater-level decimal place is added, the values can be rounded to a real-world currency value when the player elects to withdraw his or her account balance from the account. As more fully explained below, if a player desires to withdraw the money from his account, then the account balance can be rounded to an available denomination (monetary unit) in the real world. In some embodiments, downward rounding is performed; in other embodiments, upward rounding is performed; in still other embodiments, rounding is performed to the nearest available denomination and amounts exactly between the nearest denomination are rounded upward or downward or alternatingly upward and downward. This rounding can be performed at the game level (within the game and before the final game session account balance is passed back to the gaming platform) or by the gaming platform.

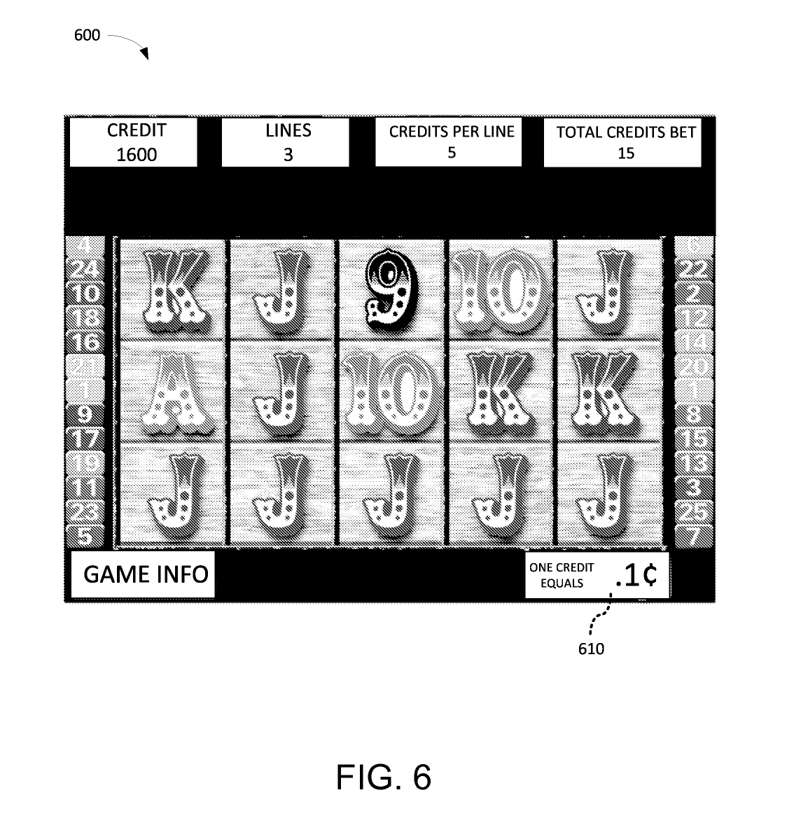

Games that are designed to use credits (as opposed to a real-world currency value) or games that were designed for real-world currency but can be converted into credits can also be used to support microstake gaming. For example, FIG. 6 is an example screen shot 600 of a slot game in which account balances are tracked as a credit value. Because credits are non-denominational, the example screen shot includes a credit value display 610 that indicates that each credit wagered is worth $0.001 or 0.1¢. In this example, support for each credit being valued at less than the lowest denomination in the desired currency is provided in the native code for the game.

If a game is being converted to a microstake game from an existing land-based game, then the game math may also be modified. Several exemplary approaches that can be used to change a game's math are disclosed in the following paragraphs. In these embodiments, the modifications allow games originally designed for land-based use to continue to accept and award only real-world currency amounts, but provide wagering options that are effectively microstake wagering options. In other words, the example modifications described still result in per-game wagers and prize results that have real-world currency values.

In one exemplary embodiment, the prize amounts awarded in the pay table are reduced by the same factor (divisor) so that the prize amounts during microstake wagering result in integer outcomes. If a prize in the paytable is not divisible by the same factor that the paylines are reduced (the division does not lead to an integer), then the amount of the prize in the paytable can be modified to make them divisible (leading to an integer). For example, for a 20-payline slot game in which all winning combinations in the game's paytable have an even integer prize amount, every prize amount can be reduced by the same factor of 2 (and lead to an integer outcome). This will work quite easily as long as each prize award in the paytable is divisible by 2 (all prizes are even numbers). If any prize amount is an odd number, however, the game developer can modify the math table to change it to an even number.

Other divisors are also possible (such as 3, 4, 5, or 10) depending on the original prize amounts from the game's paytable or the flexibility to make modifications to the paytable when the divisor does not result in integer values. For instance, if major modifications are necessary to the paytable to achieve integer results after the divisor is applied, the desired range and separation between prize amounts may be adversely affected.

Furthermore, the divisor that is applied to the paytable prizes to create microwagering opportunities can be dependent on the paylines that are available for wagering in the game. For example, for a 25-payline slot game (having a minimum wager of 25¢ to play 25 lines at 1¢ per line), one would not want to reduce the cost to play by ½ since each spin would then cost an uneven 12.5 cents, which the original land-based game would not support without more significant modification. Rather, one could reduce the cost to play and associated prize payouts by ⅕ so that the minimum cost to spin would be a nickel. As another example, for a 20-payline slot game with a minimum bet of 20¢ for 20 lines, the minimum bet can be reduced by ½ to only 10¢ per spin. As another example, a 9- or 15-payline slot game having a minimum wager of 9 or 15 can be reduced by a factor of 3. This means that all prizes in the game should also be divisible by 3, which can be achieved through appropriate modification of the math table as necessary.

In further embodiments, the available payline wagering options are modified so that the paytable prize amounts are capable of being modified by the desired divisor. For instance, the number of paylines in a 25-payline slot game may be modified to 24-lines in order to allow a divisor of 2 to be applied to the paytable prize amounts and to support microstake wagering of 0.5¢. Similarly, the minimum wager (or other wager options) can be adjusted to allow for microstakes wagering. For instance, for a 20-payline slot game that allows for single payline wagers of 1¢, the wagering options can be modified so that a minimum of 2 paylines must be wagered and all combinations of payline selection involve even paylines in order to allow a divisor of 2 to be applied to the paytable prize amounts and to support microstakes wagering of 0.5¢. Certain games (like progressives, or 25-line games as mentioned above) are more difficult to modify without changing the number of paylines or some major logic in the game math, so this approach has some limitations.

In another exemplary embodiment, the minimum bet is modified so that all lines are required to be played and every prize amount in the pay table is reduced by the same factor/divisor so that the results lead only to integer outcomes. This approach is similar to the one in the previous paragraphs but focuses on reducing the total bet and forcing a player to play all paylines (or, as described above, multiples of paylines that result in wagers that correspond to real-world currency values). In this embodiment, the prizes per payline can be awarded with precision (an exact value can be achieved via the pay table), but when each spin ends, the total prize is desirably defined in the smallest unit of currency acceptable by the platform (e.g., 1¢).

In still other embodiments, a common divisor is applied to the prize results in the paytable, but prize values are permitted to be less than the lowest real-world denomination. In this case, since some of the numbers will frequently be less than 1¢, rounding up or down may be performed (e.g., either at the end of each game or at the end of a game play session when the user selects to exit a game). Rounding may be problematic as a situation could arise where a certain bet level would have higher payout than “normal” game play, which is desirably avoided. One way to avoid this potential problem is to always round down. For example, all wins can be rounded down to the nearest integer (to 1¢ precision). However, this will cause the payout of the game to be slightly lower when played at a “sub 1¢ level”. This possibility can be disclosed in the game rules so it is transparent to the players. In other embodiments of this approach, rounding is not performed from within the game, but is instead handled at the gaming platform level, as discussed in the following paragraphs.

To support games that have been modified to allow for microstake wagers, the gaming platform for launching the games and that provides accounting functions for the player can also be configured to provide third (or greater) decimal place support. For example, an online gaming platform can have system-wide/global third (or greater) decimal place support. If a player desires to withdraw the money from his account, then the account balance can be rounded to an available denomination. In some embodiments, downward rounding is performed (e.g., 0.014¢ and 0.019¢ are rounded to 0.01¢). In other embodiments, upward rounding is performed (e.g., 0.014¢ and 0.019¢ are rounded to 0.02¢). In still other embodiments, rounding is performed to the nearest available denomination and amounts exactly between the nearest denomination are rounded upward or downward or alternatingly upward and downward (e.g., 0.014¢ is rounded to 0.010¢, 0.019¢ is rounded upward to 0.020¢, and 0.015¢ is rounded down to 0.010¢).

In some embodiments, the platform includes third decimal place support and allows players to bet microstakes during a gaming session for a particular game, but performs rounding at the end of the gaming session for that particular game (e.g., using any of the rounding methods described above). This can make it easier for an online gaming platform to support entire libraries from a range of different game developers that offer two and/or three decimal place support.

As will be appreciated, some examples may provide a mechanism by which player interest in a game can be maintained for longer. In particular, according to some examples, the availability of microstakes wagering allows for prolonged game play of a wager-based game for an available account balance of a player that would otherwise allow for game play for a much shorter period of time. Further, according to some examples, a prize amount and/or credit value is displayed to the user which is representative of the prize amount and/or credit value which may actually be paid to the user if the user wins or withdraws the money but which cannot be the actual value which is payable (withdrawable) to the user in a real-world currency. Instead, rounding techniques (e.g., downward rounding) may be used to arrive at an actual value based on the prize amount and/or credit value. This may encourage users to continue to play (e.g., to avoid downward rounding) and may maintain their interest in the game.

B. Example Gaming Platform Embodiments that Enable Microstake Wagering without Modifying Game Code

This section describes various embodiments for gaming platforms that support microstake wagering without necessarily having to modify game math or, in some instances, game code. For example, the gaming platform can add “credit support” at the system level of an online gaming platform to convert real money to credits and vice versa.

In one example embodiment, the system platform is configured to convert a player's balance from real money currency to credits when playing a slot game in a low-stakes room and then convert credits back to currency when the player exits the slot game. One example approach is to use a pop-up window, menu, or other user interface when a player opens a slot game as a means to enable that player to convert their balance from real money currency to credits at a translation rate(s) that either the player can select based on their own interests or that the operator can select itself. For instance, the user may be presented with a variety of conversion options (e.g., “click here to convert every 1¢ of real money currency into 2 credits”) for a game selected to be played or for games in a virtual low-stakes gaming room (also referred to as a “low-stakes gaming lobby”) where the player can select a game to play.

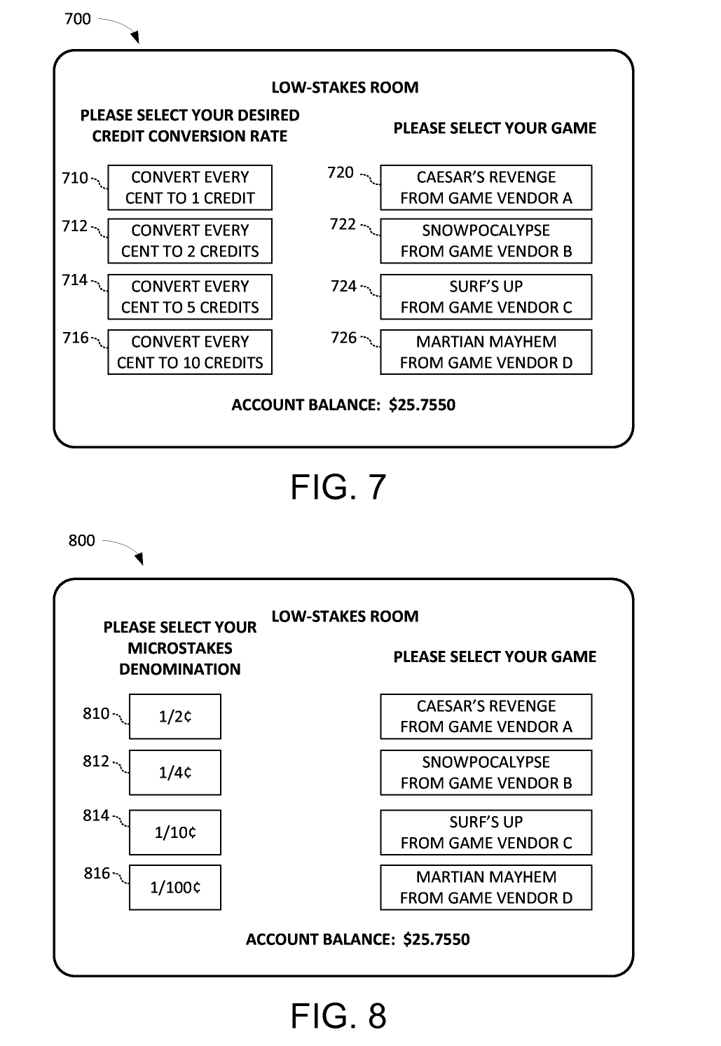

For example, FIG. 7 is an example screen shot 700 that schematically shows a low-stakes gaming room that includes one or more credit conversion buttons 710, 712, 714, 716 that are selectable by a user based on the user's desired conversion rate. The selection can then be used to determine the appropriate credit conversion rate that is applied to the player's available balance. After conversion by the gaming platform, the number of credits available to play can be provided for use during game play (e.g., through the game's API, the gamer server's API, and/or the platform's API). Also shown in FIG. 7 are game selection buttons 720, 722, 724, 726 for launching one or more games for play. As illustrated, the available games can include games from different vendors. Furthermore, in this example, the available games are games configured to operate on a credit basis (as opposed to a real-world currency) or games that operate on a real-world currency basis but also have credit support (e.g., games that operate on a credit basis but assume a credit corresponds to a real-world currency value (1¢, 5¢, 10¢, 25¢)).

It should be understood that the credit conversion buttons can present the credit conversion in a number of different manners. For instance, FIG. 8 is another example screen shot 800 where conversion buttons 810, 812, 814, 816 allow the user to select a desired microdenomination for a game. A microdenomination selection screen as in FIG. 8 can be used, for example, not only for games having credit support but also for games having real-money support (e.g., games that operate with a real-world currency that do not natively support microstakes wagering). The selection by a user of one of the available conversion buttons can then be used to determine the appropriate conversion rate that is applied to the player's available balance. After conversion, the number of credits available to play can be provided for use during game play (e.g., through the game's, game server's, and/or platform's API). Or, for games that operate with a real-world currency, the converted account balance (also referred to as a “virtual account balance”) can be provided for use during game play. Examples of converting a real-world account balance into a converted account balance for use in games that do not support credits but instead support real-world currencies are discussed in more detail below with respect to FIGS. 11-13.

In certain embodiments, the number of available of conversion rates displayed to the player is selected by the gaming platform operator. For example, the gaming platform operator can limit or expand the number of conversion rate options to any desired number. In further embodiments, the gaming platform operator can select the conversion rate for the player such that the conversion rate is not player selectable. The gaming platform can also be configured to change the number or type of conversion rate options (or the conversion rate itself) based on a variety of different factors, including the time of day, the day of the week, player preference information stored by the platform, for promotional purposes, the geographic location of the player, or any other suitable factor.

Furthermore, although FIGS. 7 and 8 show example screens through which a player can select both a conversion rate and a game, it should be understood that the conversion rate can be selected separately from the game and in any order relative to the game selection. For instance, the gaming platform may present a game selection screen before a conversion screen or vice versa.

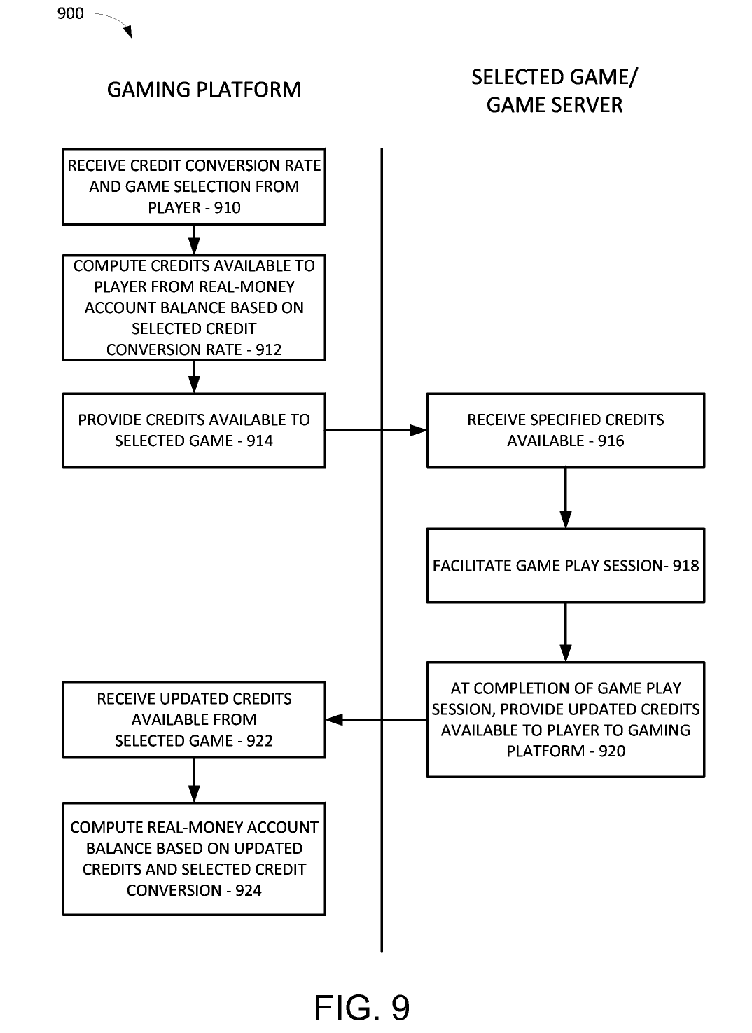

FIG. 9 is a flowchart 900 illustrating one example for implementing microstake gaming via a gaming platform according to one exemplary embodiment of the disclosed technology. As shown by FIG. 9, portions of the illustrated embodiment can be implemented by the gaming platform, which can be configured to interact with the game play modules (e.g., potentially through an intermediate component, such as a game management component 1424 of a game server). Other portions of the method shown in FIG. 9 can be implemented by the game play modules, which are configured to pass information back to the gaming platform (e.g., potentially through an intermediate component, such as a game management component 1424 of a game server).

At 910, a credit conversion rate and game selected by the player is received (e.g., data is received via a game lobby interface such as in FIG. 7 or FIG. 8 indicating the credit conversion rate and game selected by a player).

At 912, the number of credits available to a player is computed from, for example, a real-money account balance based on the selected credit conversion rate. For instance, a process can be performed that converts the player's real-money account balance (e.g., $10.00) into a converted balance of credits based on the selected credit conversion rate (e.g., a converted credit balance of 2,000 credits if the player's selected a credit conversion rate of 2 credits for every cent and the real-world balance is $10.00). The real-money account balance can be a total account balance for the player that is to be available for use during game play, or can be an account balance that is a portion of the total balance and that is selected by the user from the total amount and provided as a separate account balance for use during game play.

At 914, data indicating the credits available for the selected game (e.g., as determined form the credit conversion) is provided to the selected game(s). For instance, after the available credits are determined, the value of the available credits are passed to the game via the game's, game server's, and/or platform's API.

At 916, the data indicating the credits available for the selected game is received by the selected game (e.g., via the game's API, game server's API, and/or the platform's API). For instance, the game inputs the available credits and uses the input to determine the number of credits available to the player for game play and displays this amount as the player's initial number of credits.

At 918, game play of the selected game is facilitated. For example, one or more plays of the selected game are performed.

At 920, at completion of game play (e.g., at completion of a session of multiple plays of the game), data indicating the credits available to the player after the game play session is passed to the gaming platform (e.g., the updated number of credits available to the player after game play is passed to the gaming platform). For instance, this information can be passed back to the gaming platform via the game's API, game server's API, and/or the platform's API.

At 922, the updated number of credits available to the player after game play is received by or otherwise input in the gaming platform. For instance, the data indicating this information can be passed to the gaming platform via the game's API, game server's API, and/or the platform's API.

At 924, an updated account balance (e.g., a real-money account balance based on the currency supported by the gaming platform) is computed based at least in part on the number of credits received at 922 and the selected credit conversion rate for the player (according to the selected credit conversion rate from 910).

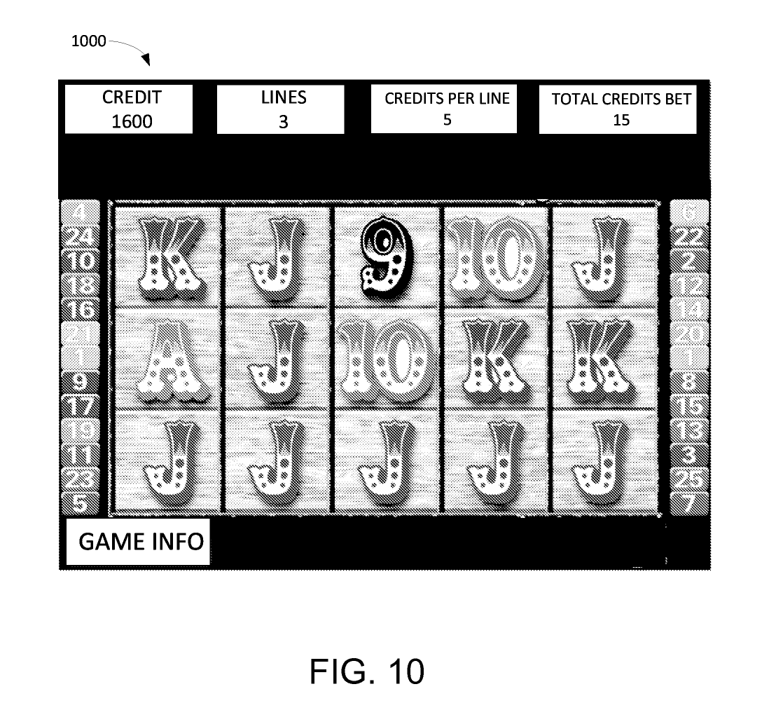

FIG. 10 is an example screen shot 1000 of a slot game in which account balances are tracked as a credit value. The credit-based slot game of FIG. 10 can be launched from the gaming lobby of FIG. 7 or FIG. 8 and can be passed a player's available credits through a credit conversion process as shown in FIG. 9. Notably, and in some embodiments, the game image displayed to the player during game play does not need to be modified since the credit conversion is performed prior to game play and notification to the player is provided.

Further, in certain embodiments, the game platform is configured to account for and/or track player account data as games are selected and played. For instance, in some embodiments, player activity is tracked during game play and used to accumulate player-tracking statistics or for player account management that can be used to provide incentives and/or rewards to a player based on the player's activity. Additionally, the disclosed platform-wide embodiments can be used to facilitate access and accountability for multiple games from multiple different vendors. In further embodiments, real money currency is converted to credits for each and every spin.

In some embodiments, a credit conversion rate can be selected within the game itself on a per spin basis. For instance, a credit conversion rate button can be included on the game's button panel (including possibly even on the spin button) or on a website area adjacent to the button panel. By enabling a player to choose to play at low stakes from or adjacent to the betting panel of each game, a player can decide whether to convert to microstakes in real time or substantially real-time while already in a play session rather than having to make this decision in advance while still in the game lobby.

In other embodiments, the game selected by the player may be a game that is played using a real-world currency (a game that is not based on credits). For instance, the game may be an online game that shows the player's account balance in terms of a real-world currency with no microstake or credit support and/or shows the player's wager in terms of a real-world currency with no microstake or credit support. To facilitate microstake gaming activity in such situations, and in certain embodiments of the disclosed technology, the gaming platform tracks and makes visible to a player one or more values (displayed, for example, in terms of a real-money but with microstakes support (e.g., by displaying values to a third or greater decimal place)) to the real money value) that represent various items of game play information (e.g., available balance, total amount of wager, amount wagered per line, minimum wager, total amount won, and other such game play statistics). In such embodiments, the gaming platform operated by an online casino operator can add one or more meters (e.g., that are in sync with the data feeds provided by the games) that are overlayed onto (or replace portions of) the game display or displayed in real estate adjacent to the games. The area where these meter(s) are displayed can be within the game window (or wrapper) itself or can be displayed outside the game window. This allows a player to track their actual, real-world account balance when the actual online slot game does not have microstake support internally and does not support wagering based on credits.

For example, FIG. 11 shows a screenshot 1100 of an original game display 1101 in which wagers and account information is tracked and displayed in terms of a real-world currency (here, dollars). FIG. 11 also shows a screenshot 1110 of a modified game display 1111 in which one or more portions of the game display are modified to support microstake wagering. In particular, one or more of display portions 1120, 1122, 1124, and 1126 of the modified game display 1111 are superimposed over (or replace) their respective original display portions shown in screenshot 1100 and show the converted values of the respective gaming statistics in place of the gaming statistics displayed natively in screenshot 1100. In the illustrated embodiment, the display portions 1120, 1122, 1124, 1126 show the game play information and converted amounts in terms of a real-world currency but with microstakes support (e.g., by adding a third or further decimal place). Thus, the display portions display the actual real-money values (with microstakes support) for the player. In FIG. 11, for instance, display portion 1120 shows the amount available to wager, display portion 1122 shows the amount bet per selected payline, display portion 1124 shows the total amount of the wager, display portion 1126 shows the total win for the game (after a spin).

The superimposed or replacement portions can be generated using a variety of technologies, such as picture-in-picture technology, rendering additional windows or display panes on top of the existing display, or by receiving and directly modifying the rendered game display image. In some embodiments, the image content data for the original game display 1101 is intercepted and supplemented with image content data for the overlayed or replacement display portions. For instance, the image content data can be provided from the game server 1404 to the internet gaming platform server 1402, which can then render the new display portions in place of the original image content data and transmit the resulting combined image content data to a user's remote computing device (e.g., any of devices 1450, 1452, 1454). In other embodiments, image content data for the original game display 1101 and image content data for the overlayed or replacement display portions are separately transmitted to the remote user's computing device from the game server 1404 and the internet gaming platform server 1402, respectively, and the rendering of the composite image is performed locally by the remote user's computing device. Further, the modified game display 1111 can be configured for presentation on the particular display device of the user's remote device using known display techniques. In certain example implementations, the image content data includes game play information (e.g., game outcome data (such as the random numbers generated by the RNG component, win data, and/or account balance data (original or updated as disclosed herein)) or other game play data (such as paylines bet, amount bet per payline, total bet (original or updated as disclosed herein))); in other example implementations, the image content data has finer granularity and can include, for instance, pixel data or a parameterized representation of graphical content (e.g., display primitives for a graphics sub-system); in still other implementations, the image content data comprises combinations thereof. Still further, the image content data may be transformed (e.g., upon rendering) from image content data of a coarser granularity into image content data of a finer granularity adapted for a particular display environment.

FIG. 12 shows another screenshot 1200 of an original game display 1201 as in FIG. 11 and a screenshot 1210 of a modified game display 1214 comprising a game display portion 1211 where the original game display 1201 is reduced in size (e.g., by scaling (using, for instance, appropriate downsampling) or cropping of the image content data for the original game display 1201) and a supplemental display portion 1212 in which supplemental information is provided. The supplemental display portion 1212 can be made available through the reduction in size of the original display. In this embodiment, the native image content of the original display is maintained but supplemented by the display portion 1212, which displays to the player conversions of in-game information into real-world currency value (e.g., values that indicate the actual value of the wagers being made by the player and/or the actual value of the account balance). In other words, the display portion 1211 may display a first set of values that indicate player account and wager information within the game, while supplemental display portion 1212 displays a second set of values that displays the actual (or real-money) account and wager information for the game converted according to the selected conversion rate and that provides microstakes support (e.g., by displaying values to three or more decimal places). In still further embodiments, the original game display 1201 is not reduced, but the supplemental information is displayed in a window, region, or area outside of the original game play window.

In some embodiments, the image content data for the original game display 1201 is intercepted, scaled (or cropped), and supplemented with the image content data for supplemental display portion 1212. For instance, the image content data for the original game display 1201 can be provided from the game server 1404 to the internet gaming platform server 1402, which can then scale (or crop) the original game display, generate the supplemental display portion 1212, and render and transmit the combined image content data to a user's remote computing device (e.g., any of devices 1450, 1452, 1454). In other embodiments, data for the original game display 1201 and data for the supplemental display portion 1212 are separately transmitted to the remote user's computing device from the game server 1404 and the internet gaming platform server 1402, respectively, and the rendering of the composite image is performed locally by the remote user's computing device. Further, the modified game display 1214 can be configured for presentation on the particular display device of the user's remote device using known rendering and image display techniques. In certain example implementations, the image content data includes game play information (e.g., game outcome data (such as the random numbers generated by the RNG component, win data, and/or account balance data (original or updated as disclosed herein)) or other game play data (such as paylines bet, amount bet per payline, total bet (original or updated as disclosed herein))); in other example implementations, the image content data has finer granularity and can include, for instance, pixel data or a parameterized representation of graphical content (e.g., display primitives for a graphics sub-system); in still other implementations, the image content data comprises combinations thereof. Still further, the image content data may be transformed (e.g., upon rendering) from image content data of a coarser granularity into image content data of a finer granularity adapted for a particular display environment.

The game display techniques of FIGS. 11 and 12 are not limited for use only with games that display wager and balance information in terms of a real-world currency, but can also be used with other types of games (e.g., games with credit support). For example, the game display of a credit-based game can be modified in order to overlay (or replace) display portions showing in-game information in terms of actual real-world currency value that accounts for the selected microstake conversion rate and that provides microstakes support (e.g., by displaying values to three or more decimal places). For instance, the credit-supporting game display of screenshot 1000 in FIG. 10 can be modified to show microstakes-supporting display portions, resulting in a display like display 1111 of FIG. 11. Or, the game display of a credit-based game can be rendered to simultaneously provide supplemental information in a window, region, or area outside of the game play window, the supplemental information showing in-game information in terms of actual real-world currency value that accounts for the selected microstake conversion rate and that provides microstakes support (e.g., by displaying values to three or more decimal places). For instance, the credit-supporting game display of screenshot 1000 in FIG. 10 can be modified to have microstakes-supporting display portions next to or adjacent a game play display portion, resulting in a display like display 1214 of FIG. 12 but with the credit-supporting game display being in place of game play display 1211.

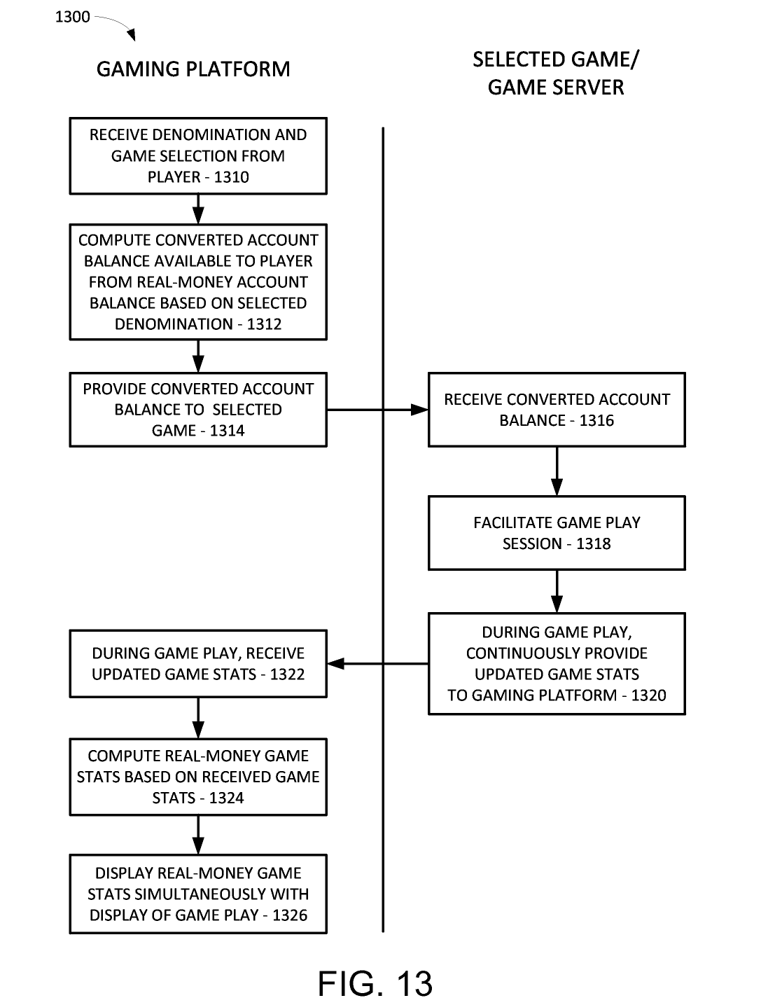

FIG. 13 is a flowchart 1300 illustrating one example for implementing a microstakes game via a gaming platform according to one exemplary embodiment of the disclosed technology. In one example implementation, the microstakes game in FIG. 13 does not support credits but operates using a player's account balance in terms of a currency (e.g., dollars). In another example implementation, the microstakes game in FIG. 13 does support credits. As shown by FIG. 13, portions of the illustrated embodiment can be implemented by the gaming platform, which can be configured to interact with the game play modules (e.g., potentially through an intermediate component, such as a game management component 1424 of a game server). Other portions of the method shown in FIG. 13 can be implemented by the game play modules, which are configured to pass information back to the gaming platform (e.g., potentially through an intermediate component, such as a game management component 1424 of a game server).

At 1310, a microstakes denomination and game selected by the player is received (e.g., data is received via a game lobby interface such as in FIG. 8 indicating the microstake denomination and game selected by a player). For instance, data indicating that the player has selected the minimum bet to be ½¢, ¼¢, ⅕¢, 1/10¢, or any other fractional wager amount below the lowest available currency (monetary unit) can be received.

At 1312, a converted account balance available to the player is computed from, for example, a real-money account balance based on the selected denomination. For instance, a process can be performed that converts the player's real-money account balance (e.g., $10.00) into a converted account balance (sometimes referred to as a “virtual account balance”) in the currency of the game based on the selected denomination (e.g., a converted balance of $20.00 if the player's selected denomination is ½¢ and the real-money balance is $10.00). The real-money account balance can be a total account balance for the player that is to be available for use during game play, or can be an account balance that is a portion of the total balance and that is selected by the user from the total amount and provided as a separate account balance for use during game play.

At 1314, data indicating the converted balance is provided to the selected game. For instance, after the converted account balance is determined, the value of the converted balance is passed to the game via the game's, game server's, and/or platform's API. It should be noted that even though this value can be in terms of a real-world currency (e.g., dollars), it represents a converted balance that accounts for the player's desired microstake wager. In this sense, then, it is a virtual balance that allows a game designed for a real-world currency to be played with a microstake wager.

At 1316, the data indicating the converted account balance available for the selected game is received by the selected game (e.g., via the game's, game server's, and/or platform's API). For instance, the game inputs the converted account balance and uses the input to determine the account balance available to the player for game play and displays this amount as the player's initial balance.

At 1318, game play of the selected game is facilitated. For example, one or more plays of the selected game are performed.

At 1320, as game play proceeds, game play statistics are provided to the gaming platform as each game is played (e.g., any one or more of: the updated balance available to the player after a game is played, the total amount wagered for a particular game, the amount won for a particular game, the number of paylines bet, the amount wagered per payline, etc.). This information can be passed back to the gaming platform, for instance, via the game's, game server's, and/or platform's API.

At 1322, the updated gaming statistics are received by the gaming platform as game play proceeds. For instance, the data indicating this information can be passed to the gaming platform via the game's, game server's, and/or platform's API.

At 1324, the updated gaming statistics are converted into real-money gaming statistics (e.g., statistics indicating the actual value of the player's account balance, total amount wagered, amount won, amount wagered per payline, and/or other such statistics). This computation can be based on the player's denomination selection made at 1310.

At 1326, one or more of the real-money gaming statistics are displayed to the player. For instance, in particular embodiments, the real-money gaming statistics are displayed to the player simultaneous with game play. The display of the statistics can be performed using a variety of techniques. For example, the display can be performed by overlaying (or substituting) the one or more statistics in place of the in-game (or virtual) statistics (e.g., as shown in FIG. 11) or can be displayed in a dedicated area adjacent to the game play display (e.g., as shown in FIG. 12). When the statistics are displayed adjacent to the game play display, the game play display can be reduced or not. Further, the converting and display of converted gaming statistics can be performed continuously or substantially continuously during game play so that the user can view a current state of the game in terms of real-money gaming statistics (including wager selection display portions (updated as the user changes his or bet) and/or game outcome display portions (updated upon completion of a game)) in real-time or substantially real-time.

In this manner, the gaming platform can support microstake wagering without having to modify game math or, in some instances, game code. Instead, games designed to operate on a real-world currency basis can be used to facilitate microstake wagering.

Further, and similar to the gaming-platform-level support for microstakes gaming described in the previous section, to further support games that do not natively support microstake wagers, the gaming platform for launching the games and that provide accounting functions for the player can be configured to provide third (or greater) decimal place support. For example, an online gaming platform can have system-wide/global third (or greater) decimal place support. If a player desires to withdraw the money from his account, then the account balance can be rounded to an available denomination. In some embodiments, downward rounding is performed (e.g., 0.014¢ and 0.019¢ are rounded to 0.01¢). In other embodiments, upward rounding is performed (e.g., 0.014¢ and 0.019¢ are rounded to 0.02¢). In still other embodiments, rounding is performed to the nearest available denomination and amounts exactly between the nearest denomination are rounded upward or downward or alternatingly upward and downward (e.g., 0.014¢ is rounded to 0.010¢, 0.019¢ is rounded upward to 0.020¢, and 0.015¢ is rounded down to 0.010¢).

As noted above, generating a modified display for a game in order to provide microstakes support can be performed in a variety of manners. For example, the gaming platform server 1402 can be configured to receive a rendered game image, user interface, or other display (or part thereof) from the game server 1404. The gaming platform server 1402 can be further configured to modify the received game image, user interface, or display (or part thereof) as discussed above, before that modified image, user interface, or display (or part thereof) is output for display to the user (e.g. via the network 1406 for display on one or more of the computing devices 1450,1452,1454). The game server 1404 can, accordingly, be unaware of the modification and unhindered in its operation. The game image, user interface, or display (or part thereof) received from the game server 1404 can include the game play image data.

The rendering of the game image, user interface, or display (or a part thereof) can also be performed by the gaming platform server 1402, in some examples, based on game play information received at the gaming platform server 1402 from the game server 1404. For instance, the gaming platform server 1402 can be provided with code for the rendering of the game image, user interface, or display from the game vendor for a particular game. The gaming platform server 1402 can be configured, therefore, to use this code to render the game image, user interface, or display and then, subsequently or as part of the rendering, modify the image, user interface, or display as discussed above.

The rendering of the modified game image, user interface, or display (or a part thereof) can also be performed by any of the computing device 1450, 1452, 1454, in some examples. For instance, the rendering can be based on game play information received from the gaming platform server 1402, at least a portion of the game play information may have been forwarded from the game server 1404 to the gaming platform server 1402. In other examples, the computing device 1450, 1452, 1454 can be configured to render a modified game image, user interface or display in accordance with the game play information originating from the gaming platform server 1402 and with game play information originating from the game server 1404. In such examples, the computing device 1450, 1452, 1454 can be configured to use game play information originating from the gaming platform server 1402 instead of or in addition to corresponding game play information originating from the game server 1404 in order to provide a rendered modified game image, user interface, or display in one or more of the forms discussed above. In some similar examples, the gaming platform server 1402 can be configured to receive game play information from the game server 1404 and to replace at least a portion of that game play information with new game play information prior to that game play information being sent to the computing device 1450, 1452, 1454 such that the modified game images, user interfaces, or displays discussed above can be rendered on the computing device 1450, 1452, 1454.

Examples of the disclosed technology can, therefore, provide a new layer which intercepts and modifies information which is received before passing the modified information to the intended recipient, such that the game code which is not designed for microstake wagering can be used without modification. As will be understood, examples of the disclosed technology allow different interactions with the game, and maintain player interest for longer, without modifying or being dependent on the rules of the game being played.

Further, in some examples, one game server 1404 can be used in relation to games which use microstake wagering and in relation to games which do not use microstake wagering. This can be achieved without the game server 1404 being aware of which games are being played using microstake wagering and which are using conventional (non-microstake) wagering.

Similarly, one gaming platform server 1402 can be configured to provide a game using microstake wagering and a game not using microstake wagering at substantially the same time. Indeed, in such examples, both games may even use the same game server 1404.

Some examples of the disclosed technology can, therefore, provide a mechanism by which an existing gaming infrastructure can be used to provide microstake gaming alongside conventional gaming. This can reduce the requirement for additional hardware, and, in some cases, simplify compliance with regulatory requirements.

As will also be appreciated, some examples of the disclosed technology can provide a mechanism by which player interest in a game can be maintained for longer. In particular, according to some examples, the availability of microstakes wagering as disclosed in this section allows for prolonged game play of a wager-based game using an available account balance for a player that would conventionally sustain game play for a much shorter period of time. Further, according to some examples, a prize amount and/or credit value is displayed to the user which is representative of the prize amount and/or credit value which may actually be paid to the user if the user wins or withdraws the money but which cannot be the actual value which is payable (withdrawable) to the user in a real-world currency. Instead, rounding techniques (e.g., downward rounding) may be used to arrive at an actual value based on the prize amount and/or credit value. This can encourage users to continue to play (e.g., to avoid downward rounding) and can maintain their interest in the game.

In the examples described above with respect to FIGS. 11 and 13, support for microstakes wagering is provided by the gaming platform (e.g., by the gaming platform server 1402). It is to be understood that support for microstakes wagering can also be provided by one or more components or modules within the game server (e.g., game server 1404). For instance, the game server can have a component that provides for microstakes support according to any of the disclosed microstake selection, conversion, and/or display techniques described. This component can still be separate from the game code that drives the selected game such that the game code remains unmodified, thereby enabling microstakes gaming in situations whether the game code does not natively provide microstakes support. This game server component can perform any of the credit or balance conversions for microstakes wagering (as part of game launch, during game play, and/or upon a game session being completed, as discussed below) and interface with the game (e.g., via a game-specific API or other game-specific control mechanism) as described above (e.g., with respect to game management component 1416). Further, this game server component can perform any of the described display techniques for providing the microstakes-supported displays, as in FIGS. 11 and 12. Still further, this game server component may provide a microstakes wager selection interface through which a player can select a desired microstakes wager amount as disclosed herein. In such embodiments, the gaming platform server can still interface with the game server (via the platform's and/or game server's API) and provide game selection and initial game configuration data to the game server (e.g., data indicating a selected game, player identification, available balance for use during game play, and other such initiation data), but the support for microstakes gaming using any of the disclosed techniques is provided through an interface layer of the game server.

C. Other General Embodiments Applying the Disclosed Microstakes Technology

This section presents several representative embodiments of methods, apparatus, and systems in accordance with the technology disclosed herein. The disclosed methods, apparatus, and systems should not be construed as limiting in any way. As with the embodiments elsewhere described, any features or aspects of the disclosed embodiments can be used in various combinations and subcombinations with one another.

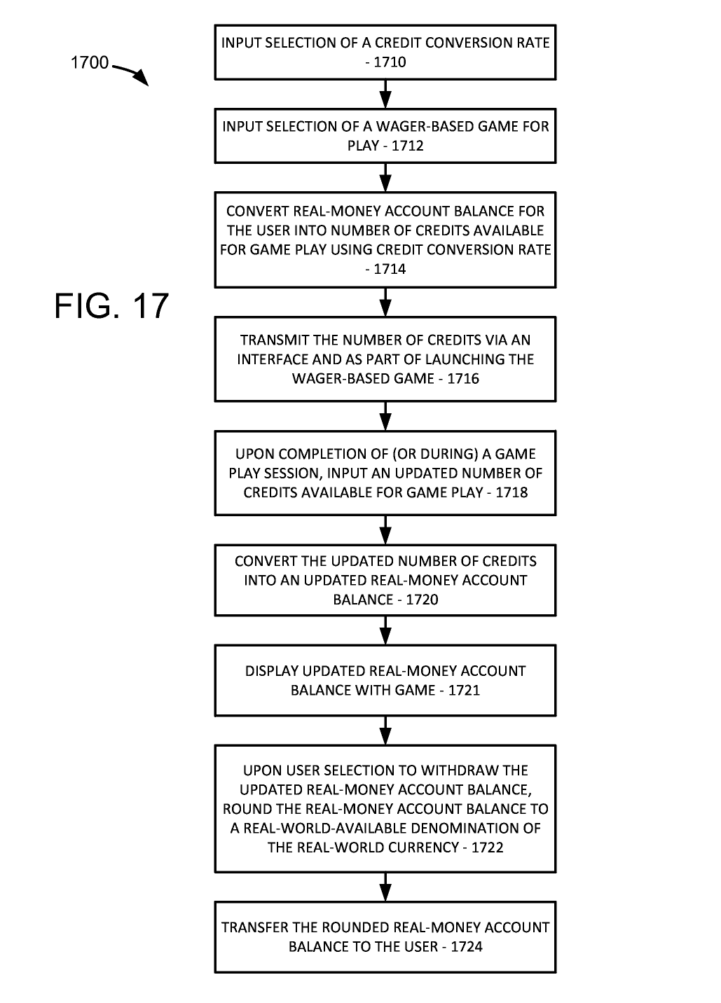

FIG. 17 is a flow chart 1700 showing an example embodiment for implementing microstakes wagering according to the disclosed technology. The technique illustrated in FIG. 17 is based on but not limited by FIG. 9. The particular operations and sequence of operations should not be construed as limiting, as they can be performed alone or in any combination, subcombination, and/or sequence with one another. Additionally, the illustrated operations can be performed together with one or more other operations. Still further, the identified operations need not be performed by a single software module, but can be implemented using multiple modules or software tools, which collectively perform the illustrated method. The example embodiment of FIG. 17 can be performed, for example, by a gaming platform server (e.g., an internet gaming platform server) comprising one or more processing units programmed or configured to provide an online gaming platform by which a user can play one or more wager-based games on a remote device operated by the user and in communication with the gaming platform server. Alternatively, the example embodiment of FIG. 17 can be performed, at least in part, by a game server comprising one or more processing units programmed or configured to provide online wager-based games that a user can play on a remote device operated by the user and in communication with the game server and/or an associated gaming platform server. The example embodiment of FIG. 17 can also be performed by software and/or hardware incorporated into or in communication with a game offered by a gaming machine in the land-based casino context in order to facilitate microstakes wagering.

At 1710, a selection of a credit conversion rate is input from a user, the credit conversion rate describing how to convert a real-money account balance for the user into a number of credits available to the user for game play, the real-money account balance being for a real-world currency.

At 1712, a selection of a wager-based game for play by the user is input from the user.

At 1714, the real-money account balance for the user is converted into the number of credits available to the user for game play. In one example implementation, the credit conversion rate results in a single one of the credits having a value in terms of the real-world currency that is less than a lowest real-world-available denomination of the real-world currency. The real-money account balance can be a total account balance for the player that is to be available for use during game play (the seamless wallet approach), or can be an account balance that is a portion of the total balance and that is selected by the user from the total amount and provided as a separate account balance for use during game play.

At 1716, the number of credits available to the user for game play for use with the selected wager-based game is transmitted (e.g., via an interface and as part of launching the wager-based game). This data can be transmitted to, for example, a game server (such as a remote game server), which can then provide the data to the game module for the selected game (potentially via a separate API or game control mechanism). Or, in cases where a component of a game server separate from the underlying game code provides the microstakes support, this data can be passed (transmitted) directly to the game.

At 1718, upon completion of (or during) a game play session comprising a plurality of game plays of the selected wager-based game, an updated number of credits available to the user for game play is input.

At 1720, the updated number of credits is converted into an updated real-money account balance using the selected credit conversion rate that was used to determine the number of credits available to the user transmitted as part of the launching of the wager-based game.

In some embodiments, the updated number of credits is received by the gaming platform server only after a user selects to exit the selected wager-based game and not between games of the wager-based game during the game play session. In other embodiments, during a game play session comprising a plurality of game plays of the selected wager-based game, an updated number of credits available to the user for game play is received. For instance, the updated number of credits can be received (e.g., by the gaming platform server) as each game of the game play session is completed. In the illustrated embodiment, the updated number of credits is converted into an updated real-money account balance using the selected credit conversion rate, and, at 1721, a display (also referred to as a user interface or screen) is caused to be presented to the user via a display device on the remote device that displays the updated real-money account balance together with the selected wager-based game. For instance, the causing the display to be presented can include intercepting image content data for a game play display for the selected wager-based game and modifying the image content data for the game play display to create the display to be presented to the user.

At 1722, upon the user selecting to withdraw the updated real-money account balance, the real-money account balance is rounded to a real-world-available denomination of the real-world currency.

At 1724, the rounded real-money account balance is transferred to the user. For example, the account balance (or any selected portion thereof) can be transferred to another account associated with the user (e.g., such as a bank account (via ACH transfer) or to a credit card account (by processing a credit to the user in the amount of the requested withdrawal).

In certain embodiments, other game play statistics are also received by the gaming platform, converted into real-money amounts, and displayed to the player upon completion of (or during) a game play session. For instance, in some implementations, the game play statistics (including the updated real-money account balance) are updated and displayed continuously during game play (e.g., to provide real-time or substantially real-time microstakes support to the user). In some embodiments, the method is performed by a gaming platform server and a game server is configured or programmed to receive, via the interface, the number of credits available from the gaming platform server; facilitate a game play session of one or more game plays by the user of the selected wager-based game, the wager-based game providing credit support, an initial available credit balance for the user being set for the game play session at the number of credits received from the gaming platform server; and transmit an updated number of credits to the gaming platform server. The game server can be a separate server from the gaming platform server, or the game server can be the same server as the gaming platform server (e.g., the gaming platform and game server functionalities are provided by the same server or set of servers operated by a single entity). In certain embodiments, a game server executes executable code for the selected wager-based game without knowledge or use of the real-money account balance, while in other embodiments, the game server is configured to perform the microstakes conversion technique. In some embodiments, the wager-based game is a wager-based slot game. In other embodiments, the wager-based game is another game of chance (e.g., online poker game, bingo game, horse race game, other card game, craps game, roulette game, or any other recognized wager-based game of chance). In certain embodiments, the selected wager-based game natively provides only credit support. In some embodiments, the interface is one or more of an application programming interface for a game server or an application programming interface for the wager-based game. The application programming interface(s) can be provided, for example, by a game developer for the wager-based game, the game developer being a separate entity from a provider of the gaming platform. In some embodiments, rounding is performed as part of the conversion process from the updated number of credits to an updated real-money account balance such that the updated real-money account balance is rounded (upward or downward) to the lowest real-world available denomination of the real-world currency. In such instances, for example, the selected wager-based game and rounding are such that a plurality of wins or losses of the selected wager-based game is required to increase or decrease the real-money account balance by the lowest real-world-available denomination of the real-world currency. In further embodiments, the gaming platform is configured to facilitate game play by any desired number of remote users and can also provide non-microstakes-based wager for games. For instance, in one example embodiment, the gaming platform server is further configured to: input, from a second user, a selection of a second credit conversion rate to convert a real-money account balance for the second user into a number of credits available to the second user for game play, the real-money account balance being for a real-world currency; input, from the second user, a selection of a wager-based game for play by the second user; convert the real-money account balance for the second user into the number of credits available to the second user for game play, the credit conversion rate resulting in a single one of the credits having a value in terms of the real-world currency that is an integer multiple of the lowest real-world-available denomination of the real-world currency; and transmit, via an interface, the number of credits available to the second user for game play for use with the selected wager-based game.

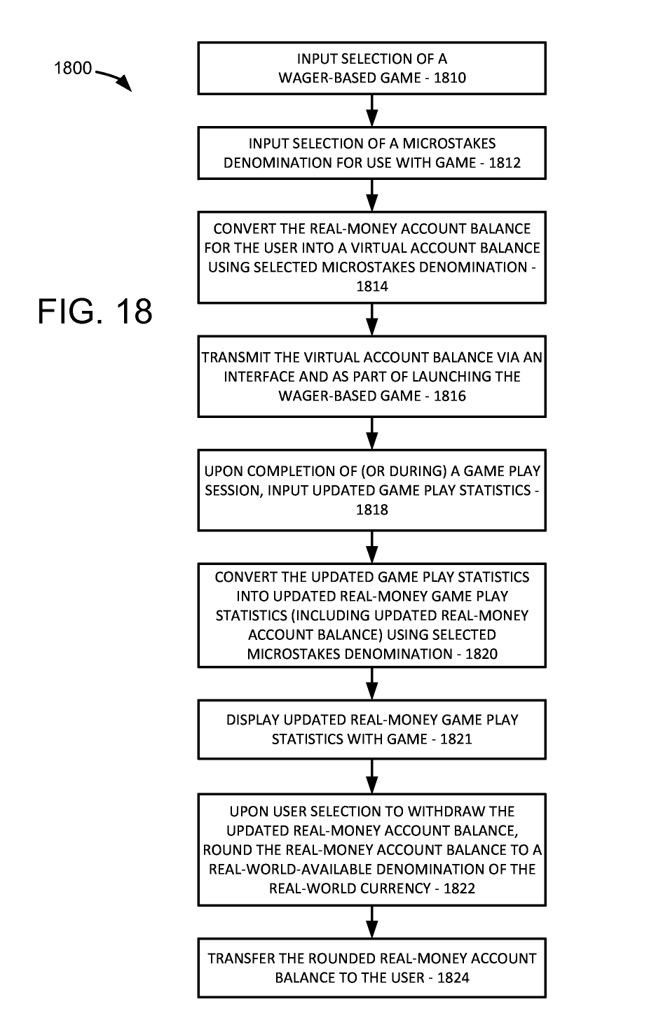

FIG. 18 is a flow chart 1800 showing an example embodiment for implementing microstakes wagering according to the disclosed technology. The technique illustrated in FIG. 18 is based on but not limited by FIG. 13. The particular operations and sequence of operations should not be construed as limiting, as they can be performed alone or in any combination, subcombination, and/or sequence with one another. Additionally, the illustrated operations can be performed together with one or more other operations. Still further, the identified operations need not be performed by a single software module, but can be implemented using multiple modules or software tools, which collectively perform the illustrated method. The example embodiment of FIG. 18 can be performed, for example, by a gaming platform server (e.g., an internet gaming platform server) comprising one or more processing units programmed or configured to provide an online gaming platform by which a user can play one or more wager-based games on a remote device operated by the user and in communication with the gaming platform server. Alternatively, the example embodiment of FIG. 18 can be performed, at least in part, by a game server comprising one or more processing units programmed or configured to provide online wager-based games that a user can play on a remote device operated by the user and in communication with the game server and/or an associated gaming platform server. The example embodiment of FIG. 18 can also be performed by software and/or hardware incorporated into or in communication with a game offered by a gaming machine in the land-based casino context in order to facilitate microstakes wagering.

At 1810, a selection of a wager-based game offered by the online gaming platform is input from the user.

At 1812, a selection of a microstakes denomination for use with the selected game is input from the user, the microstakes denomination being represented in terms of a real-world currency but of a value that is less than a lowest real-world-available denomination of the real-world currency.

At 1814, a real-money account balance for the user is converted into a virtual account balance using the selected microstakes denomination, the real-money account balance being in terms of the real-world currency. The real-money account balance can be a total account balance for the player that is to be available for use during game play (the seamless wallet approach), or can be an account balance that is a portion of the total balance and that is selected by the user from the total amount and provided as a separate account balance for use during game play.

At 1816, the virtual account balance for use during game play of the selected wager-based game is transmitted (via an interface and as part of launching the game). This data can be transmitted to, for example, a game server (such as a remote game server), which can then provide the data to the game module for the selected game (potentially via a separate API or game control mechanism). Or, in cases where a component of a game server separate from the underlying game code provides the microstakes support, this data can be passed (transmitted) directly to the game.

At 1818, during a game play session for the selected wager-based game, updated game play statistics are input.

At 1820, the updated game play statistics are converted into real-money game play statistics using the selected microstakes denomination, the real-money game play statistics including an updated real-money account balance.

In certain embodiments, the updated game play statistics are continuously received by the gaming platform server as each game of the game play session is played. In other embodiments, the game play statistics are only received at completion of a game play session in which multiple games of the selected wager-based game are played. In the illustrated embodiment, the updated game play statistics are converted into real-money game play statistics using the selected microstakes denomination, and, at 1821, a display (or user interface, or screen) is caused to be displayed to the user via a display device of the user's remote device, the display displaying the real-money game play statistics together with the selected wager-based game. For example, the display presented to the user can comprise one or more display portions that are overlayed onto (or replace portions of) a game play screen for the selected wager-based game and that display the updated game play statistics. For instance, the one or more overlayed (or replacement) display portions can display the game play statistics in terms of the real-world currency but with one or more additional decimal places than are natively supported by the selected wager-based game, thus providing microstake support for the wager-based game. As another example, the display presented to the user can comprise a real-money game play statistics display portion that displays the updated real-money game play statistics adjacent to a game play display portion that displays the game play. For instance, the game play display portion can be reduced in size but otherwise unmodified from its native appearance. Further, in certain embodiments, the causing the display to be presented can include intercepting image content data for a game play display for the selected wager-based game and modifying the image content data for the game play display to create the display to be presented to the user. As noted, in some implementations, the game play statistics are updated and displayed continuously during game play (e.g., to provide real-time or substantially real-time microstakes support to the user)

At 1822, upon the user selecting to withdraw the updated real-money account balance, the real-money account balance is rounded to a real-world-available denomination of the real-world currency.

At 1824, the rounded real-money account balance is transferred to the user. For example, the account balance (or any selected portion thereof) can be transferred to another account associated with the user (e.g., such as a bank account (via ACH transfer) or to a credit card account (by processing a credit to the user in the amount of the requested withdrawal).

In some embodiments, the method is performed by a gaming platform server and a game server is configured or programmed to: input, via the interface, the virtual account balance from the gaming platform server; and facilitate a game play session of one or more games played by the user of the selected wager-based game, the wager-based game being real-money-based, an available account balance for the user being initially set for the game play session at the received virtual account balance. The game server can be a separate server from the gaming platform server, or the game server can be the same server as the gaming platform server (e.g., the gaming platform and game server functionalities are provided by the same server or set of servers operated by a single entity). In some embodiments, a game server executes executable code for the selected wager-based game without knowledge or use of the real-money account balance. In certain embodiments, the wager-based game is a wager-based slot game. In other embodiments, the wager-based game is another game of chance (e.g., online poker game, bingo game, horse race game, other card game, craps game, roulette game, or any other recognized wager-based game of chance). In certain embodiments, the selected wager-based game natively provides only credit support. In some embodiments, the interface is one or more of an application programming interface for a game server or an application programming interface for the wager-based game. The application programming interfaces can be provided, for example, by a game developer for the wager-based game, the game developer being a separate entity from a provider of the gaming platform. In further embodiments, the gaming platform is configured to facilitate game play by any desired number of remote users and can also provide non-microstakes-based wager for games. For instance, in one example embodiment, the gaming platform server is further configured to: input, from a second user, a selection of a game offered by the online gaming platform; input, from the second user, a selection of a denomination for use with the selected game, the denomination being represented in terms of a real-world currency and of a value that is an integer multiple of the lowest real-world-available denomination of the real-world currency; and transmit, via an interface, the selected denomination for use during game play of the selected wager-based game.

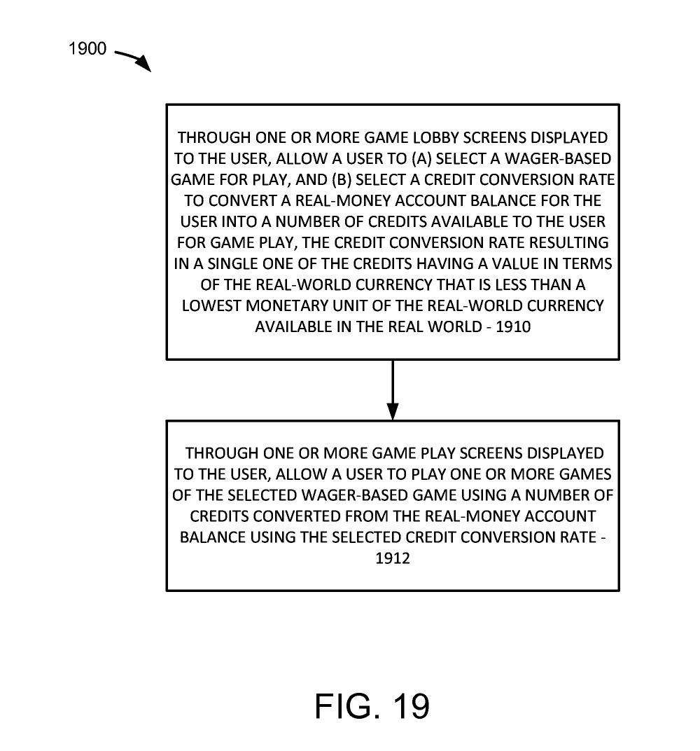

FIG. 19 is a flow chart 19 showing an example embodiment of the user experience flow according to embodiments of the disclosed technology. The particular operations and sequence of operations should not be construed as limiting, as they can be performed alone or in any combination, subcombination, and/or sequence with one another. Additionally, the illustrated operations can be performed together with one or more other operations. Still further, the identified operations need not be performed by a single software module, but can be implemented using multiple modules or software tools, which collectively perform the illustrated method. The example embodiment of FIG. 19 can be performed, for example, by a computing device operated by a user, comprising: a display device; one or more computer-readable memory or storage components; and one or more processing units. The computing device can be configured or programmed to provide online, internet-based, gaming via communications with a remote gaming platform server and/or remote game server (via a web browser or dedicated app executing at the computing device), the remote gaming platform server and remote game server facilitating game play at the computing device of one or more wager-based games. The example embodiment of FIG. 19 can alternatively be performed at a gaming machine in the land-based casino context by software and/or hardware incorporated into or in communication with a game offered by the gaming machine.

At 1910, through one or more game lobby screens displayed to the user, a user is allowed to (a) select a wager-based game for play by the user, and (b) select a credit conversion rate to convert a real-money account balance for the user into a number of credits available to the user for game play, the real-money account balance being for a real-world currency, the credit conversion rate resulting in a single one of the credits having a value in terms of the real-world currency that is less than a lowest monetary unit of the real-world currency available in the real world. The real-money account balance can be a total account balance for the player that is to be available for use during game play (the seamless wallet approach), or can be an account balance that is a portion of the total balance and that is selected by the user from the total amount and provided as a separate account balance for use during game play.

At 1912, through one or more game play screens displayed to the user, a user is allowed to play one or more games of the selected wager-based game using a number of credits converted from the real-money account balance using the selected credit conversion rate.

In certain embodiments, after the player selects to exit the one or more game play screens and through an updated version of at least one of the game lobby screens, an updated real-money account balance is displayed to the user that accounts for the one or more games played by the user and the selected credit conversion rate. In other embodiments, through the one or more game play screens displayed to the user, updated real-money game play information is simultaneously displayed with the game play of the selected wager-based game, the updated real-money game play information being converted from credit-based game play information using the selected credit conversion rate. For example, the simultaneous display can be performed through one or more display portions that are overlayed onto (or replace portions of) a game play screen for the selected wager-based game and that respectively display the updated real-money game play information. As another example, the simultaneous display is performed through one or more display portions that are displayed adjacent to a display portion showing game play for the selected wager-based game, the adjacent one or more display portions displaying the updated real-money game play information. In some embodiments, the computing device can generate the one or more game play screens by intercepting one or more original game play screens and modifying the or each original game play screen to create the one or more game play screens displayed to the user. In particular implementations, the computing device is a mobile device, the display device is a touchscreen through which selections by the user are input, and the mobile device further comprises a wireless transceiver configured to communicate wirelessly with the remote gaming platform server and game server.

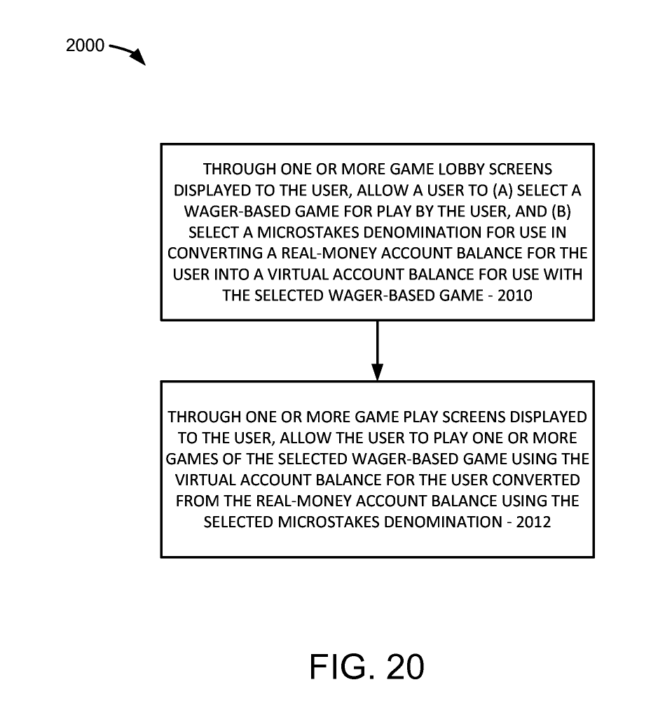

FIG. 20 is a flow chart 2000 showing an example embodiment of the user experience flow according to embodiments of the disclosed technology. The particular operations and sequence of operations should not be construed as limiting, as they can be performed alone or in any combination, subcombination, and/or sequence with one another. Additionally, the illustrated operations can be performed together with one or more other operations. Still further, the identified operations need not be performed by a single software module, but can be implemented using multiple modules or software tools, which collectively perform the illustrated method. The example embodiment of FIG. 20 can be performed, for example, by a computing device operated by a user, comprising: a display device; one or more computer-readable memory or storage components; and one or more processing units. The computing device can be configured or programmed to provide online, internet-based, gaming via communication with a remote gaming platform server and remote game server (via a web browser or dedicated app executing at the computing device), the remote gaming platform server and remote game server facilitating game play at the computing device of one or more wager-based games. The example embodiment of FIG. 20 can alternatively be performed at a gaming machine in the land-based casino context by software and/or hardware incorporated into or in communication with a game offered by the gaming machine.

At 2010, through one or more game lobby screens displayed to the user, a user is allowed to (a) select a wager-based game for play by the user, and (b) select a microstakes denomination for use in converting a real-money account balance for the user into a virtual account balance for use with the selected wager-based game, the microstakes denomination being represented in terms of a real-world currency but of a value that is less than a lowest monetary unit of the real-world currency available in the real world, the real-money account balance being in terms of the real-world currency. The real-money account balance can be a total account balance for the player that is to be available for use during game play (the seamless wallet approach), or can be an account balance that is a portion of the total balance and that is selected by the user from the total amount and provided as a separate account balance for use during game play.

At 2012, through one or more game play screens displayed to the user, the user is allowed to play one or more games of the selected wager-based game using the virtual account balance for the user converted from the real-money account balance using the selected microstakes denomination.

In some embodiments, through the one or more game play screens displayed to the user, updated real-money game play information is simultaneously displayed with the game play of the selected wager-based game, the updated real-money game play information being converted from game play information that is based on the virtual account balance and that is converted using the selected microstakes denomination. For example, the simultaneous display can be performed through one or more display portions that are overlayed onto (or replace portions of) a game play screen for the selected wager-based game and that respectively display the updated real-money game play information. As another example, the simultaneous display can be performed through one or more display portions that are displayed adjacent to a display portion showing game play for the selected wager-based game, the adjacent one or more display portions displaying the updated real-money game play information. In some embodiments, the computing device can generate the one or more game play screens by intercepting one or more original game play screens and modifying the or each original game play screen to create the one or more game play screens displayed to the user. In particular implementations, the computing device is a mobile device, wherein the display device is a touchscreen through which selections by the user are input, and wherein the mobile device further comprises a wireless transceiver configured to communicate wirelessly with the remote gaming platform server and game server.

Also disclosed herein are examples of games that have been originally created or been modified to support microstakes wagering. Such games can created or modified (using any of the modification techniques described herein) and stored on a tangible non-transitory computer-readable medium. For instance, such games can be stored, for instance, on a game server and made available for play by a user (e.g., without using any of the microstake conversion techniques introduced herein). Thus, also within the scope and disclosure of the present application is a system, comprising: a game server comprising one or more processing units and one or more tangible non-transitory computer-readable media, the one or more tangible non-transitory computer-readable storing computer-executable instructions which when executed by one or more of the processing units cause the game server to facilitate game play of one or more wager-based games at a remote device operated by a user (e.g., a mobile device communicating with the game server via the internet). In such embodiments, at least one of the one or more wager-based games is a microstakes-supporting wager-based game that allows the user to make a wager in terms of a real-world currency but in an amount that is less than a smallest real-world monetary unit of the real-world currency. In certain embodiments, the microstakes-supporting wager-based game displays one or more of wager amounts, wins, or available balance via respective display portions showing values to three or more decimal places. In some embodiments, the microstakes-supporting wager-based game is a modified version of a wager-based game that did not natively support microstakes wagers. In particular implementations, the modified version of the wager-based game is modified, at least in part, by transforming a pay table of the wager-based game such that all available win amounts are divisible by a divisor corresponding to the smallest wagerable microstakes wager and still result in an integer win amount. In some implementations, the modified version of the wager-based game is modified, at least in part, by transforming a pay table of the wager-based game such that all available win amounts are divisible by an amount sufficient to support a smallest available microstakes wager for the wager-based game while still providing win amounts payable in the real-world currency. In certain implementations, the modified version of the wager-based game is modified, at least in part, by restricting the available selection of paylines for wagering by the user such that all win amounts from a pay table for the wager-based game are payable in the real-world currency. In some implementations, the modified version of the wager-based game is modified, at least in part, by modifying a minimum amount of microstake wagers that can be made by a user such that all win amounts from a pay table for the wager-based game are payable in the real-world currency. In certain embodiments, the modified version of the wager-based game is modified, at least in part, by restricting the available selection of paylines for wagering and also modifying the minimum number of microstakes wagers that can be made for each payline such that multiple microstake wagers must be bet for at least one of the available paylines. In some embodiments, games are offered that do not have microstakes support along with games that do have microstakes support (in which cases, the non-microstakes-supporting games can be implemented to have microstakes support using any of the techniques described above for providing microstakes support without modifying game code). For instance, in one embodiment, there are a plurality of wager-based games and at least one of the plurality of wager-based games is a wager-based game that only allows the user to make a wager in terms of a real-world currency in an amount that is an integer multiple of a smallest real-world monetary unit of the real-world currency.

For any of the disclosed embodiments in which micro stakes support is provided, the microstakes wager can be less than the lowest (smallest) available denomination (monetary unit) for a real-world currency. For instance, (a) the real-world currency can be the currency of the United States and the wager-based game with microstakes support allows the user to make a wager that is less than one U.S. cent; (b) the real-world currency can be the currency of the Euro zone and the wager-based game with microstakes support allows the user to make a wager that is less than one Euro cent; (c) the real-world currency can be the currency of Great Britain and the wager-based game with microstakes support allows the user to make a wager that is less than one pence; (d) the real-world currency can be the currency of Australia and the wager-based game with microstakes support allows the user to make a wager that is less than one Australian cent; or (e) the real-world currency can be the currency of South Africa and the wager-based game with microstakes support allows the user to make a wager that is less than one South African cent.

Having described and illustrated the principles of the innovations in the detailed description and accompanying drawings, it will be recognized that the various embodiments can be modified in arrangement and detail without departing from such principles.

For instance, the disclosed technology is not limited to internet-based games. Instead, the technology can also be adapted for use with land-based gaming machines and/or casino management systems. For example, any land-based casino gaming machine can be designed or adapted to support microstake wagering by extending the decimal place in a credit meter or, for games with credit support, including a credit conversion screen that allows a player to select a conversion rate for microstake wagers. Still further, the technology can be incorporated into casino management systems that control multiple gaming machines. For instance, while the gaming machines may be gaming machines that do not inherently support microstake wagering, they may send game play information to a back-end server that performs the microstake wagering conversion and accounting in real-time. Thus, the back-end server can serve to monitor the player's account as game play proceeds at the gaming device (e.g., the server can act as the player's wallet). In particular implementations, the back-end server can communicate data back to the gaming machine indicative of the player's account balance during a game play session (e.g., in real-time). This account information can then be displayed to the player separately from the credit meter or account meter of the gaming machine (e.g., on a player tracking device or separate device attached to the machine or in a window adjacent to the game display) or superimposed onto the game play display of the machine as described above. Still further, this information can be used by the gaming machine when the player selects to cash out so that the proper account balance can be distributed to the player (e.g., printed on the account ticket for the player). Still further, through such casino-based control, a variety of other microstake wagering opportunities can be created. For instance, in one implementation, gaming machines can selectively be transitioned to support microstake wagering for time periods selected by the casino (e.g., happy hour or any other desired time period).

Further, although the technology is generally described above as being applied to games of chance, it can be used with other types of wagering games. For example, computer versions of table and card games can support microstake wagering using any of the disclosed embodiments. Still further, physical tables and card games can be designed to include microstake wagering opportunities by applying the methodologies discussed above.

Still further, while the conversions performed to provide microstakes support for games that do not natively provide such support have typically been described herein as being performed by the gaming platform server or by a component of the game server separate from the game code, the conversions can, in some cases, be at least partially or completely performed by the remote computing device operated by the user.

In view of the many possible embodiments to which the principles of the disclosed technology may be applied, it should be recognized that the illustrated embodiments are only preferred examples of the disclosed technology and should not be taken as limiting the scope of the invention. Rather, the scope of the invention is defined by the following claims and their equivalents. We therefore claim all that comes within the scope and spirit of these claims and their equivalents.

1. A system, comprising:
a gaming platform server comprising one or more processing units programmed or configured to provide an online gaming platform by which a user can play one or more wager-based games on a remote device operated by the user and in communication with the gaming platform server,
the one or more processing units of the gaming platform server being further programmed or configured to:
input, from a user, a selection of a credit conversion rate to convert a real-money account balance for the user into a number of credits available to the user for game play, the real-money account balance being for a real-world currency;
input, from the user, a selection of a wager-based game for play by the user;
convert the real-money account balance for the user into the number of credits available to the user for game play, the credit conversion rate resulting in a single one of the credits having a value in terms of the real-world currency that is less than a lowest real-world-available denomination of the real-world currency; and
transmit, via an interface and as part of launching the wager-based game, the number of credits available to the user for game play for use with the selected wager-based game.

2. The system of claim 1, wherein the one or more processing units of the gaming platform server are further programmed or configured to:
upon completion of a game play session comprising a plurality of game plays of the selected wager-based game, input an updated number of credits available to the user for game play; and
convert the updated number of credits into an updated real-money account balance using the selected credit conversion rate that was used to determine the number of credits available to the user transmitted as part of the launching of the wager-based game.

3. The system of claim 2, wherein the updated number of credits is received by the gaming platform server only after a user selects to exit the selected wager-based game and not between games of the wager-based game during the game play session.

4. The system of claim 2, wherein the one or more processing units of the gaming platform server are further programmed or configured to:
upon the user selecting to withdraw the updated real-money account balance, round the real-money account balance to a real-world-available denomination of the real-world currency; and
transfer the rounded real-money account balance to another account for the user.

5. The system of claim 1, wherein the one or more processing units of the gaming platform server are further programmed or configured to:
during a game play session comprising a plurality of game plays of the selected wager-based game, receive an updated number of credits available to the user for game play, wherein the updated number of credits is received by the gaming platform server as each game of the game play session is completed.

6. The system of claim 5, wherein the one or more processing units of the gaming platform server are further programmed or configured to:
convert the updated number of credits into an updated real-money account balance using the selected credit conversion rate; and
cause a display to be presented to the user via a display device on the remote device, the display displaying the updated real-money account balance together with the selected wager-based game.

7. The system of claim 6, wherein causing the display to be presented includes intercepting image content data for a game play display for the selected wager-based game and modifying the image content data for the game play display to create the display to be presented to the user.

8. The system of claim 1, further comprising:
a game server comprising one or more processing units, the one or more processing units of the game server being programmed or configured to:
receive, via the interface for the selected wager-based game, the number of credits available from the gaming platform server;
facilitate a game play session of one or more game plays by the user of the selected wager-based game, the wager-based game providing credit support, an initial available credit balance for the user being set for the game play session at the number of credits received from the gaming platform server; and
transmit an updated number of credits to the gaming platform server.

9. The system of claim 8, wherein the game server is a separate server from the gaming platform server.

10. The system of claim 8, wherein the game server is the same server as the gaming platform server.

11. The system of claim 8, wherein the game server executes executable code for the selected wager-based game without knowledge or use of the real-money account balance.

12. The system of claim 2, wherein:
the one or more processing units of the gaming platform server are further programmed or configured to convert the updated number of credits to an updated real-money account balance, wherein the conversion includes rounding the updated real-money account balance to the lowest real-world-available denomination of the real-world currency, and
the selected wager-based game and rounding are such that a plurality of wins or losses of the selected wager-based game is required to increase or decrease the real-money account balance by the lowest real-world-available denomination of the real-world currency.

13. The system of claim 1, wherein the wager-based game is a wager-based slot game.

14. The system of claim 1, wherein the selected wager-based game natively provides only credit support.

15. The system of claim 1, wherein the interface is one or more of an application programming interface for the game server or an application programming interface for the wager-based game.

16. The system of claim 15, wherein the one or more application programming interfaces are provided by a game developer, the game developer being a separate entity from a provider of the gaming platform.

17. The system of claim 1, wherein the one or more processing units of the gaming platform server being further programmed or configured to:
input, from a second user, a selection of a second credit conversion rate to convert a real-money account balance for the second user into a number of credits available to the second user for game play, the real-money account balance being for a real-world currency;
input, from the second user, a selection of a wager-based game for play by the second user;
convert the real-money account balance for the second user into the number of credits available to the second user for game play, the credit conversion rate resulting in a single one of the credits having a value in terms of the real-world currency that is an integer multiple of the lowest real-world-available denomination of the real-world currency; and
transmit, via an interface, the number of credits available to the second user for game play for use with the selected wager-based game.

18. A system, comprising:
a gaming platform server comprising one or more processing units programmed or configured to provide an online gaming platform by which a user can play one or more wager-based games on a remote device operated by the user and in communication with the gaming platform server,
the one or more processing units of the gaming platform server being further programmed or configured to:
input, from the user, a selection of a wager-based game offered by the online gaming platform;
input, from the user, a selection of a microstakes denomination for use with the selected wager-based game, the microstakes denomination being represented in terms of a real-world currency but of a value that is less than a lowest real-world-available denomination of the real-world currency;
convert a real-money account balance for the user into a virtual account balance using the selected microstakes denomination, the real-money account balance being in terms of the real-world currency; and
transmit, via an interface and as part of launching the wager-based game, the virtual account balance for use during game play of the selected wager-based game.

19. The system of claim 18, wherein the one or more processing units of the gaming platform server are further programmed or configured to:
during a game play session comprising multiple game plays of the selected wager-based game, receive updated game play statistics.

20. The system of claim 19, wherein the one or more processing units of the gaming platform server are further programmed or configured to:
convert the updated game play statistics into real-money game play statistics using the selected microstakes denomination that was used to determine the virtual account balance transmitted as part of the launching of the wager-based game, the real-money game play statistics including an updated real-money account balance;
upon the user selecting to withdraw the updated real-money account balance, round the real-money account balance to a real-world-available denomination of the real-world currency; and
transfer the rounded real-money account balance to another account for the user.

21. The system of claim 19, wherein the updated game play statistics are continuously received by the gaming platform server as each game of the game play session is played.

22. The system of claim 19, wherein the one or more processing units of the gaming platform server are further programmed or configured to:
convert the updated game play statistics into real-money game play statistics using the selected microstakes denomination; and
cause a display to be presented to the user via a display device of the remote device, the display displaying the real-money game play statistics together with the selected wager-based game.

23. The system of claim 22, wherein causing the display to be presented includes intercepting image content data for a game play display for the selected wager-based game and modifying the image content data for the game play display to create the display to be presented to the user.

24. The system of claim 22, wherein the display displayed to the user comprises one or more display portions that are overlayed onto or replace a game play display for the selected wager-based game, the one or more display portions displaying the updated game play statistics.

25. The system of claim 24, wherein the one or more overlayed or replaced display portions display the game play statistics in terms of the real-world currency but with one or more additional decimal places than are natively supported by the selected wager-based game, thus providing microstake support for the wager-based game.

26. The system of claim 22, wherein the display displayed to the user comprises a real-money game play statistics display portion that displays the updated real-money game play statistics adjacent to a game play display portion that displays the game play.

27. The system of claim 26, wherein the game play display portion is reduced in size but otherwise unmodified from its native appearance.

28. The system of claim 18, further comprising:
a game server comprising one or more processing units, the one or more processing units of the game server being programmed or configured to:
input, via the interface, the virtual account balance from the gaming platform server; and
facilitate a game play session of one or more games played by the user of the selected wager-based game, the wager-based game being real-money-based, an available account balance for the user being initially set for the game play session at the received virtual account balance.

29. The system of claim 28, wherein the game server is a separate server from the gaming platform server.

30. The system of claim 28, wherein the game server is the same server as the gaming platform server.

31. The system of claim 28, wherein the game server executes executable code for the selected wager-based game without knowledge or use of the real-money account balance.

32. The system of claim 18, wherein the wager-based game is a wager-based slot game.

33. The system of claim 18, wherein the selected wager-based game natively supports real-money-based wagering but not credits.

34. The system of claim 18, wherein the interface is one or more of an application programming interface for a game server or an application programming interface for the wager-based game.

35. The system of claim 34, wherein the one or more application programming interfaces are provided by a game developer for the wager-based game, the game developer being a separate entity from a provider of the gaming platform.

36. The system of claim 18, wherein the one or more processing units of the gaming platform server being further programmed or configured to:
input, from the second user, a selection of a game offered by the online gaming platform;
input, from the second user, a selection of a denomination for use with the selected game, the denomination being represented in terms of a real-world currency and of a value that is an integer multiple of the lowest real-world-available denomination of the real-world currency; and
transmit, via an interface, the selected denomination for use during game play of the selected wager-based game.

37. A computing device, comprising:
a display device;
one or more computer-readable memory or storage components; and
one or more processing units,
the computing device being programmed to provide online gaming via communication with a remote gaming platform server and remote game server, the remote gaming platform server and remote game server facilitating game play at the computing device of one or more wager-based games,
wherein the computing device is further programmed to, via the communication with the remote gaming platform server and the game server:
through one or more game lobby screens displayed to the user, allow a user to (a) select a wager-based game for play by the user, and (b) select a credit conversion rate to convert a real-money account balance for the user into a number of credits available to the user for game play, the real-money account balance being for a real-world currency, the credit conversion rate resulting in a single one of the credits having a value in terms of the real-world currency that is less than a lowest monetary unit of the real-world currency available in the real world; and
through one or more game play screens displayed to the user, allow a user to play one or more games of the selected wager-based game using a number of credits converted from the real-money account balance using the selected credit conversion rate.

38. The computing device of claim 37, wherein the computing device is further programmed to, via the communication with the remote gaming platform server and the game server:
after the player selects to exit the one or more game play screens and through an updated version of at least one of the game lobby screens, display to the user an updated real-money account balance that accounts for the one or more games played by the user and the selected credit conversion rate.

39. The computing device of claim 37, wherein the computing device is further programmed to, via the communication with the remote gaming platform server and the game server:
through the one or more game play screens displayed to the user, simultaneously display updated real-money game play information with the game play of the selected wager-based game, the updated real-money game play information being converted from credit-based game play information using the selected credit conversion rate.

40. The computing device of claim 37, wherein the computing device is further programmed to, via the communication with the remote gaming platform server and the game server:
generate the one or more game play screens by intercepting one or more original game play screens and modifying the or each original game play screen to create the one or more game play screens displayed to the user.

41. The computing device of claim 37, wherein the simultaneous display is at least partially performed through one or more display portions that are overlayed onto or replace portions of a game play screen for the selected wager-based game and that respectively display the updated real-money game play information.

42. The computing device of claim 37, wherein the simultaneous display is at least partially performed through one or more display portions that are displayed adjacent to a display portion showing game play for the selected wager-based game, the adjacent one or more display portions displaying the updated real-money game play information.

43. The computing device of claim 37, wherein the computing device is a mobile device, wherein the display device is a touchscreen through which selections by the user are input, and wherein the mobile device further comprises a wireless transceiver configured to communicate wirelessly with the remote gaming platform server and game server.

44. A computing device, comprising:
a display device;
one or more computer-readable memory or storage components; and
one or more processing units,
the computing device being programmed to provide online, internet-based, gaming via communication with a remote gaming platform server and game server, the remote gaming platform server and game server facilitating game play at the computing device of one or more wager-based games,
wherein the computing device is further programmed to, via the communication with the remote gaming platform server and the game server:
through one or more game lobby screens displayed to the user, allow a user to (a) select a wager-based game for play by the user, and (b) select a microstakes denomination for use in converting a real-money account balance for the user into a virtual account balance for use with the selected wager-based game, the microstakes denomination being represented in terms of a real-world currency but of a value that is less than a lowest monetary unit of the real-world currency available in the real world, the real-money account balance being in terms of the real-world currency; and
through one or more game play screens displayed to the user, allow the user to play one or more games of the selected wager-based game using the virtual account balance for the user converted from the real-money account balance using the selected microstakes denomination.

45. The computing device of claim 44, wherein the computing device is further programmed to, via the communication with the remote gaming platform server and the game server:
through the one or more game play screens displayed to the user, simultaneously display updated real-money game play information with the game play of the selected wager-based game, the updated real-money game play information being converted from game play information that is based on the virtual account balance and that is converted using the selected microstakes denomination.

46. The computing device of any of claim 44, wherein the computing device is further programmed to, via the communication with the remote gaming platform server and the game server:
generate the one or more game play screens by intercepting one or more original game play screens and modifying the or each original game play screen to create the one or more game play screens displayed to the user.

47. The computing device of claim 45, wherein the simultaneous display is at least partially performed through one or more display portions that are overlayed onto or replace portions of a game play screen for the selected wager-based game and that respectively display the updated real-money game play information.

48. The computing device of claim 45, wherein the simultaneous display is at least partially performed through one or more display portions that are displayed adjacent to a display portion showing game play for the selected wager-based game, the adjacent one or more display portions displaying the updated real-money game play information.

49. The computing device of claim 44, wherein the computing device is a mobile device, wherein the display device is a touchscreen through which selections by the user are input, and wherein the mobile device further comprises a wireless transceiver configured to communicate wirelessly with the remote gaming platform server and game server.

50. A system, comprising:
a game server comprising one or more processing units and one or more tangible non-transitory computer-readable media, the one or more tangible non-transitory computer-readable storing computer-executable instructions which when executed by one or more of the processing units cause the game server to facilitate game play of one or more wager-based games at a remote device operated by a user,
at least one of the one or more wager-based games being a microstakes-supporting wager-based game that allows the user to make a wager in terms of a real-world currency but in an amount that is less than a smallest real-world monetary unit of the real-world currency.

51. The system of claim 50, wherein the microstakes-supporting wager-based game is a modified version of a wager-based game that did not natively support microstakes wagers.

52. The system of claim 51, wherein the modified version of the wager-based game is modified, at least in part, by transforming a pay table of the wager-based game such that all available win amounts are divisible by a divisor corresponding to the smallest wagerable microstakes wager and still result in an integer win amount.

53. The system of claim 51, wherein the modified version of the wager-based game is modified, at least in part, by transforming a pay table of the wager-based game such that all available win amounts are divisible by an amount sufficient to support a smallest available microstakes wager for the wager-based game while still providing win amounts payable in the real-world currency.

54. The system of claim 51, wherein the modified version of the wager-based game is modified, at least in part, by restricting the available selection of paylines for wagering by the user such that all win amounts from a pay table for the wager-based game are payable in the real-world currency.

55. The system of claim 51, wherein the modified version of the wager-based game is modified, at least in part, by modifying a minimum amount of microstake wagers that can be made by a user such that all win amounts from a pay table for the wager-based game are payable in the real-world currency.

56. The system of claim 51, wherein the modified version of the wager-based game is modified, at least in part, by restricting the available selection of paylines for wagering and also modifying the minimum number of microstakes wagers that can be made for each payline such that multiple microstake wagers must be bet for at least one of the available paylines.

57. The system of claim 50, wherein the remote device is a mobile device communicating with the game server via the internet.

58. The system of claim 50, wherein there are a plurality of wager-based games and wherein at least one of the plurality of wager-based games is a wager-based game that only allows the user to make a wager in terms of a real-world currency in an amount that is an integer multiple of a smallest real-world monetary unit of the real-world currency.

59. The system of claim 50, wherein, for the microstakes-supporting wager-based game: (a) the real-world currency is the currency of the United States and the wager-based game allows the user to make a wager that is less than one U.S. cent; (b) the real-world currency is the currency of the Euro zone and the wager-based game allows the user to make a wager that is less than one Euro cent; (c) the real-world currency is the currency of Great Britain and the wager-based game allows the user to make a wager that is less than one pence; (d) the real-world currency is the currency of Australia and the wager-based game allows the user to make a wager that is less than one Australian cent; or (e) the real-world currency is the currency of South Africa and the wager-based game allows the user to make a wager that is less than one South African cent.

60. The system of claim 50, wherein the microstakes-supporting wager-based game displays one or more of wager amounts, wins, or available balance via respective display portions showing values to three or more decimal places.

61. A system, comprising:
one or more processing units programmed or configured to provide an online gaming environment by which a user can play one or more wager-based games on a remote device operated by the user,
the one or more processing units being further programmed or configured to:
input, from a user, a selection of a credit conversion rate to convert a real-money account balance for the user into a number of credits available to the user for game play, the real-money account balance being for a real-world currency;
input, from the user, a selection of a wager-based game for play by the user;
convert the real-money account balance for the user into the number of credits available to the user for game play, the credit conversion rate resulting in a single one of the credits having a value in terms of the real-world currency that is less than a lowest real-world-available denomination of the real-world currency; and
provide, via an interface and as part of launching the wager-based game, the number of credits available to the user for game play for use with the selected wager-based game.

62. The system of claim 61, wherein the one or more processing units are further programmed or configured to:
upon completion of a game play session comprising a plurality of game plays of the selected wager-based game, input an updated number of credits available to the user for game play; and
convert the updated number of credits into an updated real-money account balance using the selected credit conversion rate that was used to determine the number of credits available to the user transmitted as part of the launching of the wager-based game.

63. The system of claim 61, wherein the one or more processing units are further programmed or configured to:
during a game play session comprising a plurality of game plays of the selected wager-based game, receive an updated number of credits available to the user for game play, wherein the updated number of credits is received as each game of the game play session is completed.

64. The system of claim 62, wherein the one or more processing units are further programmed or configured to:
convert the updated number of credits into an updated real-money account balance using the selected credit conversion rate; and
cause a display to be presented to the user via a display device on the remote device, the display displaying the updated real-money account balance together with the selected wager-based game.

65. A system, comprising:
one or more processing units programmed or configured to provide an online gaming environment by which a user can play one or more wager-based games on a remote device operated by the user,
the one or more processing units being further programmed or configured to:
input, from the user, a selection of a wager-based game;
input, from the user, a selection of a microstakes denomination for use with the selected wager-based game, the microstakes denomination being represented in terms of a real-world currency but of a value that is less than a lowest real-world-available denomination of the real-world currency;
convert a real-money account balance for the user into a virtual account balance using the selected microstakes denomination, the real-money account balance being in terms of the real-world currency; and
transmit, via an interface and as part of launching the wager-based game, the virtual account balance for use during game play of the selected wager-based game.

66. The system of claim 65, wherein the one or more processing units are further programmed or configured to:
during a game play session comprising multiple game plays of the selected wager-based game, receive updated game play statistics.

67. The system of claim 66, wherein the one or more processing units are further programmed or configured to:
convert the updated game play statistics into real-money game play statistics using the selected microstakes denomination; and
cause a display to be presented to the user via a display device of the remote device, the display displaying the real-money game play statistics together with the selected wager-based game.
